(19) United States
(12) Patent Application Publication
(10) Pub. No.: US 2025/0368395 A1
(43) Pub. Date: Dec. 4, 2025

(54) Modular Storage System

(71) Applicant: YETI Coolers, LLC, Austin, TX (US)

(72) Inventors: Matthew Shaffer Corbin, San Antonio, TX (US); Steven M. Scott, Austin, TX (US); Derek G. Sullivan, Austin, TX (US)

(21) Appl. No.: 19/227,723

(22) Filed: Jun. 4, 2025

Related U.S. Application Data
(60) Provisional application No. 63/656,050, filed on Jun. 4, 2024.
(60) Provisional application No. 63/686,892, filed on Aug. 26, 2024.

(51) Int. Cl. B65D 25/20; B65D 21/02

(52) U.S. Cl. CPC B65D 25/20; B65D 21/0209

(57) ABSTRACT

A modular storage system may include at least one crate formed by a first side, a second side, a third side, a fourth side, and a bottom. The sides and the bottom may form a storage area and an opening to access the storage area. The sides and the bottom may each comprise a series of ports in which a side pattern of the series of ports for the first side, the second side, the third side, the fourth side may be different than a bottom pattern of the series of ports for the bottom, and the series of ports may be configured for mounting to objects. The crate or crates may be stackable forming the modular storage system. The crates may include a lattice structure on one or more sides. The modular system may include a connector configured to engage at least one crate at the lattice structure.

### CROSS-REFERENCE TO RELATED APPLICATIONS

This application claims the benefit of a priority to U.S. Provisional Application No. 63/656,050, filed on Jun. 4, 2024; and U.S. Provisional Application No. 63/686,892, filed on Aug. 26, 2024. The contents of the aforementioned applications are incorporated herein by reference in their entirety.

### FIELD

The present disclosure relates generally to storage systems, and in particular, modular, stackable, and integrated storage systems.

### BACKGROUND

Conventional storage systems may be used to store personal belongings in in an efficient manner. Some of these particular systems are cumbersome, occupy an excessive amount of space, and are constructed of substandard materials prone to failure and destruction.

### SUMMARY

This Summary introduces a selection of concepts relating to this technology in a simplified form as a prelude to the Detailed Description that follows. This Summary is not intended to identify key or essential features.

In some aspects, a modular storage system disclosed herein may include at least one crate formed by a first side, a second side, a third side, a fourth side, and a bottom. The first side, the second side, the third side, the fourth side, and the bottom may form a storage area and an opening to access the storage area. The first side, the second side, the third side, the fourth side and the bottom may each comprise a series of screw boss holes or ports in which a side pattern of the series of screw boss holes or ports for the first side, the second side, the third side, the fourth side may be different than a bottom pattern of the series of screw boss holes for the bottom, and the series of screw boss holes or ports may be configured for mounting to objects.

In other examples, the modular storage system may include a lid configured to removably cover the opening. In other examples, the lid may further include a latch configured to releasably engage a top portion of the crate or crates forming the modular storage system. In another example, the lid may be configured to form a friction fit with the opening in a covered or sealed position. In some examples, the lid may be formed of a clear or transparent material. In other examples, the lid may be formed of an opaque material. In other examples, some or all of the first sides, the second sides, the third sides, or the fourth sides of the crates may include a handle. In some examples, the handle may further include a crowned grip assembly. In still other examples, the crates may be stackable with other crates. In certain examples, the first side, the second side, the third side, the fourth side and/or the bottom may each include a repeating ventilated structure. In yet another example, the repeating ventilated structure or lattice may include a plurality of hexagon-shaped structures or other polygon-shaped structures. In other examples, feet may be removably attached to the bottom series of screw boss holes or ports. In another example, the feet may be reversibly attached and having a gripping side and a slidable side opposite the gripping side.

In other aspects, a modular storage system disclosed herein may include a plurality of stackable crates, and each crate may include a first side, a second side, a third side, and a fourth side, each including a handle, and a first series of screw boss holes or ports positioned in a first pattern. The modular storage system crates may also have a bottom that may include a second series of screw boss holes or ports positioned in a second pattern, and the first pattern maybe different than the second pattern. The crates may have a storage area formed by the first side, the second side, the third side, the fourth side, and the bottom form the storage area, as well as an opening formed by the first side, the second side, the third side, and the fourth side. The modular storage system may also include a lid or lids that may be configured to cover the opening of the crates.

In some examples, the first series of screw boss holes or ports and the second series of screw boss holes or ports may be configured for mounting to objects. In other examples, the second series of screw boss holes or ports may be configured to removably engage a foot. In still other examples, the foot may be reversible and may include a gripping side and a slidable side opposite the gripping side.

In still other aspects, a method of forming a modular storage system disclosed herein may include the steps of forming at least one crate having a first side, a second side, a third side, a fourth side, and a bottom. The crate may be stackable with a plurality of crates, and the first side, the second side, the third side, the fourth side, and the bottom may form a storage area and an opening to access the storage area. The first side, the second side, the third side, the fourth side and the bottom may each comprise a series of screw boss holes or ports. A side pattern of the series of screw boss holes or ports for the first side, the second side, the third side, the fourth side may be different than a bottom pattern of the series of screw boss holes or ports for the bottom. The screw boss holes or ports may also be configured for mounting to objects.

In some examples, the method of forming a modular storage system disclosed herein may include the steps of forming a removable lid that may be configured to cover or seal the opening of the crate. In another example, the first side, the second side, the third side, the fourth side, and the bottom may be formed of a repeating ventilated structure. In some examples, the repeating ventilated lattice structure may be comprised of a plurality of hexagon-shaped structures or other polygon-shaped structures.

These and additional features will be appreciated with the benefit of the disclosures discussed in further detail below.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIG. 1 depicts a perspective view of an example crate having a lid for use in forming a modular storage system, according to one or more aspects described herein.

FIG. 2 depicts a perspective view of the crate of FIG. 1 without a lid for use in forming a modular storage system, according to one or more aspects described herein.

FIG. 3A depicts a side view of the crate of FIG. 2, according to one or more aspects described herein.

FIG. 3B depicts a close up view of an exemplary carry handle of the crate of FIG. 2, according to one or more aspects described herein

FIG. 4 depicts a top view of the crate of FIG. 2, according to one or more aspects described herein.

FIG. 5 depicts a bottom view of the crate of FIG. 2, according to one or more aspects described herein.

FIGS. 6A and 6B-6D depict a bottom-perspective view and a close up views of an alternative crate having reversible feet for use in forming a modular storage system, according to one or more aspects described herein

FIG. 7A depicts a perspective view of an alternative example crate having a lid with a latch system which can be configured for forming a modular storage system, according to one or more aspects described herein.

FIG. 7B depicts a perspective view of another alternative example crate having a press fit or friction fit lid with a sealing gasket which can be configured for use in forming a modular storage system, according to one or more aspects described herein.

FIG. 7C depicts a perspective view of another alternative example crate having an opaque lid with a sealing gasket which can be configured for use in forming a modular storage system, according to one or more aspects described herein.

FIG. 8A depicts a perspective view of another alternative example crate having a partial lid/closure, which can be configured for use in forming a modular storage system, according to one or more aspects described herein.

FIG. 8B depicts a perspective view of an alternative example crate having a partial lid/drawer caddy which can be configured for use in forming a modular storage system, according to one or more aspects described herein.

FIG. 8C depicts a perspective view of another alternative example crate having a partial lid/closure with latches which can be configured for use in forming a modular storage system, according to one or more aspects described herein.

FIG. 9 depicts an example of a modular storage system, according to one or more aspects described herein.

FIG. 10A depicts an example of stacked crates of modular storage system.

FIG. 10B depicts an alternative example of stacked crates of modular storage system.

FIG. 10C depicts an alternative example of stacked crates of modular storage system.

FIG. 10D depicts an alternative example of stacked crates of modular storage system.

FIG. 11A depicts an example hexagonal connector.

FIG. 11B depicts an alternate view of the example connector of FIG. 11A.

FIG. 12 depicts the example connector of FIGS. 11A and 11B engaged with an example crate. The connector may include a mechanical fastener such as a bolt and nut.

FIG. 13A depicts a front view of an example connector of FIGS. 11A and 11B.

FIG. 13B depicts three illustrations of the example connector of FIG. 13A rotated by about 60° and overlaid.

FIGS. 14A and 14B depict example connectors engaged with an example crate and a fishing rod holder accessory.

FIG. 15 depicts example connectors engaged with an example crate and a support surface.

FIG. 16A depicts an example modular storage system including a crate and band.

FIG. 16B shows a first view of the crate of FIG. 16A with the band installed.

FIG. 16C shows an alternative view of the crate of FIGS. 16A and 16B with the band and bottom support installed.

FIG. 17A shows the crate with an exploded view of the two band halves and band connector.

FIG. 17B shows the crate of FIG. 17A with the two band halves joined via the band connector.

FIG. 17C shows the crate with an exploded view of the two band halves and an alternative example band connector.

FIG. 17D shows the crate of FIG. 17C with the two band halves joined via the band connector.

FIG. 18 depicts an example method associated with crates and connectors.

Further, it is to be understood that the drawings may represent the scale of different components of various examples; however, the disclosed examples are not limited to that particular scale. Further, the drawings should not be interpreted as requiring a certain scale unless otherwise stated.

### DETAILED DESCRIPTION

In the following description of the various examples and components of this disclosure, reference is made to the accompanying drawings, which form a part hereof, and in which are shown by way of illustration various example structures and environments in which aspects of the disclosure may be practiced. It is to be understood that other structures and environments may be utilized and that structural and functional modifications may be made from the specifically described structures and methods without departing from the scope of the present disclosure.

Also, while the terms “front,” “top,” “base,” “bottom,” and “side” and the like may be used in this specification to describe various example features and elements, these terms are used herein as a matter of convenience, e.g., based on the example orientations shown in the figures and/or the orientations in typical use. Nothing in this specification should be construed as requiring a specific three-dimensional or spatial orientation of structures in order to fall within the scope of the claims.

In the description that follows, reference is made to one or more container structures, cartons, or crates. It is contemplated that any of the disclosed structures may be constructed from any polymer, composite, metal/alloy material, polycarbonate material, alternative polymeric materials and/or combinations thereof without from the scope of these disclosures. Additionally, it is contemplated that any manufacturing methodology may be utilized, without departing from the scope of these disclosures. For example, one or more molding, injection molding, blow molding, 3D printing, stamping, welding (e.g. high frequency, ultrasonic welding, or laser welding of fabric, or metal/alloy welding), gluing, stitching, deep-drawing, casting, die-casting, drilling, deburring, grinding, polishing, sanding, or etching processes, among many others, may be utilized to construct of the various containers described throughout these disclosures.

There remains a need for a modular storage system as described. For example, disclosed herein is a simple, space efficient, adaptable, stackable, multi-functional modular storage system that may be configured in various ways and in accordance with a user's needs or requirements. The modular components of the storage system, as disclosed herein, may connect using specialized channels, ridges, connections, fasteners, etc. Moreover, the modular components may be constructed with durable materials providing increased strength and longevity. The modular components may be configured to affix and/or tie down to a platform, wall, floor, or other object. Additionally, the modular components of the storage system disclosed herein may be used to transport items via bicycle, motorcycle, scooter, vehicle, boat, aircraft, and other transportation systems known in the art.

In addition, the modular storage system described herein may take advantage of one or more lattice configured sides and/or bottom. Such configurations may impart strength while reducing weight. Additionally or alternatively, such configurations may improve the modularity of the crates. For example, as described herein, the lattice structures described may be leveraged with connectors yielding multiple advantages. For example, the connectors may be configured to engage the lattice. The lattice and connectors may be leveraged to create variously configured and oriented modular storage systems. Additionally or alternatively, the lattice and connectors may be leveraged to connect the storage system to one or more surfaces and/or to connect one or more accessories to the storage system. These and other advantages are described in more detail herein.

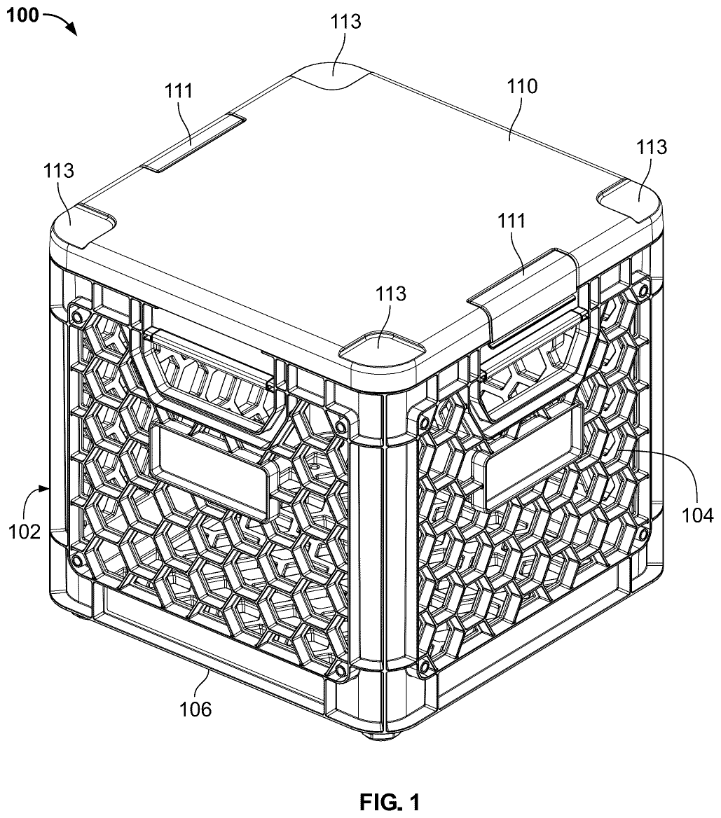

FIG. 1 depicts an implementation of a modular storage system 100, according to one or more aspects described herein. It is contemplated that the modular storage system may include crate 102. Crate 102 may alternatively be referred to as a carton, container, box, cargo crate, or cargo container, among others, as consistent with the disclosure herein. In some examples, modular storage system 100 may be compatible with other cargo systems or storage bin systems. In one example, crate 102 may have sides 104 and bottom 106 formed of a durable and lightweight material such as any polymer, composite, and/or metal/alloy material, among others. Moreover, crate 102 may be formed of a waterproof or water resistant material. Also, in this example, the crate 102 is formed in a cube shape or cuboid. But it is contemplated that the crate can be of various shapes and configurations such as other variations of box-shapes, cuboids, rectangular prisms, sided shapes. Also, certain examples may have other prism shapes or 3D shapes. It is contemplated that the exemplary shapes can be configured to form a modular system with either similar 3D shapes or different 3D shapes, which can be customizable based on storage systems and user preferences.

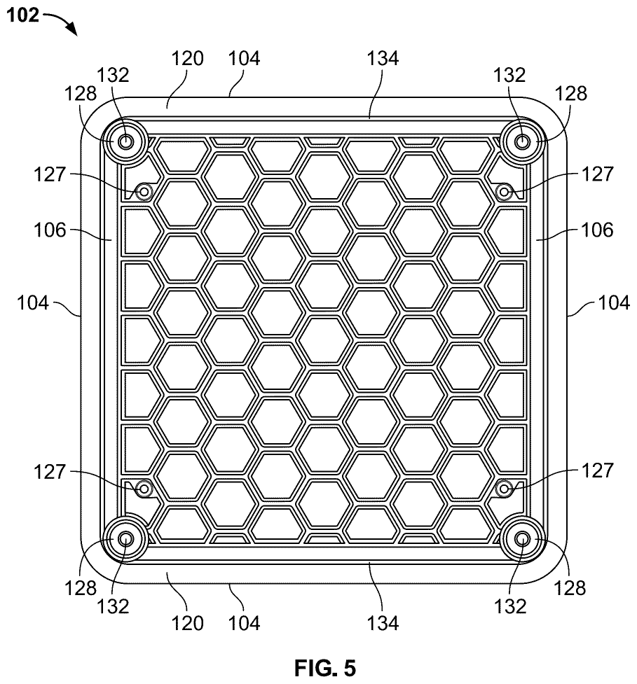

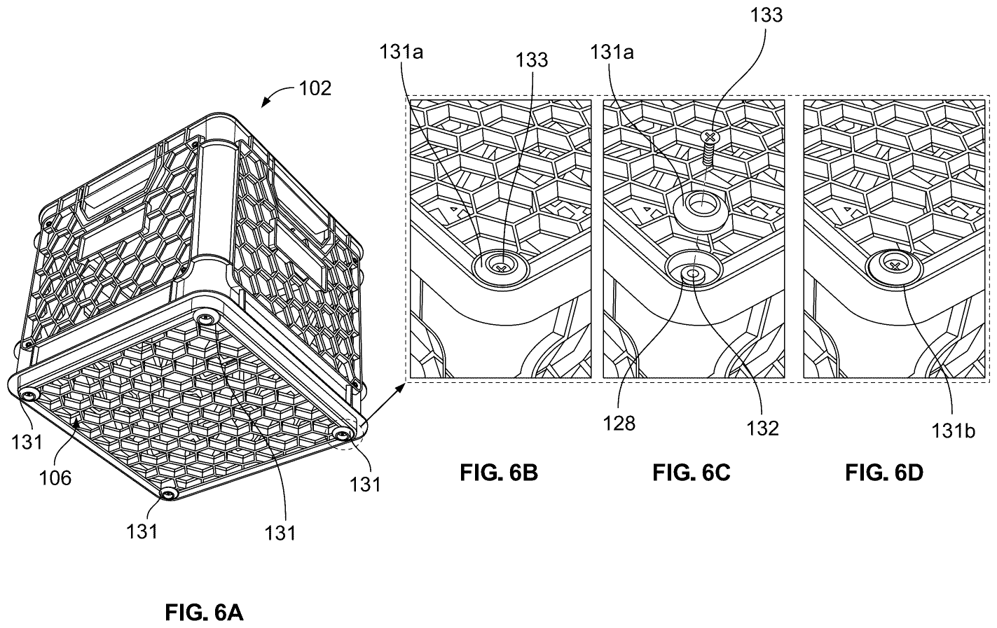

As shown in FIG. 1, the crate 102 may include lid 110 configured to attach to the top of crate 102, for example, to secure belongings within the crate storage area formed by sides or walls 104 and bottom or base 106. Lid 110 may fit over an opening formed by sides 104 that provides access to the storage area. Lid 110 may also include one or more (e.g., a series of) latches 111 configured to clamp on to sides 104. Latches 111 may be hingedly coupled to lid 110. In certain examples, the hinges of latches 111 may utilize one or more of flexure elements (e.g. living hinges), or piano hinges, pegs or posts, among many others. In some examples, latches 111 may removably engage lips or ridges positioned around the top perimeter of sides 104. When rotated downward, each latch 111 may include a ridge or structure to engage the lip or ridge to secure the lid in a locked position. Lid 110 may further include retention areas or cutouts 113 positioned on or near the corners of lid 110 for stacking a series of crates 102. Retention areas or cutouts 113 may be configured to engage bottom 106 of crate 102 for modular stacking or positioning of multiple crates 102 in a vertical orientation. In this example there can be four cutouts 113 configured to receive four corresponding feet 131 (discussed in relation to FIGS. 5-6D) on the base of the crate 102. In some examples, retention area or cutout 113 may be generally clam shell-shaped, ovoid-shaped, square-shaped, rectangular shaped, or triangular shaped. In certain examples, the retention areas or cutouts 113 can be formed open on one side for ease of stacking the crates 102 in a vertical orientation. As such the lid 110 can be provided with an interrupted rim area or one or more stepped areas for receiving a corresponding crate on the lid. Part of the retention areas or cutouts 113 can be rounded to correspond with rounded portions of the feet 131. Also, in this example, the retention areas or cutouts 113 can be formed as stepped areas so that the crates 102 can be set at a lower level for space conservation. The depth of the retention areas or cutouts 113 can be based on the height of the feet such that the space between the lid 110 and the adjacent bottom of the crate sitting on the lid 110 is minimized. Accordingly, the retention areas or cutouts 113 can each define a surface that is positioned vertically lower than a top surface of the lid.

It is also contemplated that different numbers of retention areas or cutouts 113 to correspond with different numbers of feet on the crate and/or different retention areas or cutout patterns can be implemented so the crates can be oriented in different angular patterns during stacking and storage. In another example, the retention areas or cutouts 113 can be eliminated altogether and the lid 110 can be provided with a texturized surface and/or elastomeric surface in order to better maintain a series of crates 102 in a stacked configuration. Further it is contemplated that the lid 110 include one or more attachment structures or methods as discussed herein to secure the lid 110 to its associated crate or horizontally or vertically adjacent crate or series of crates.

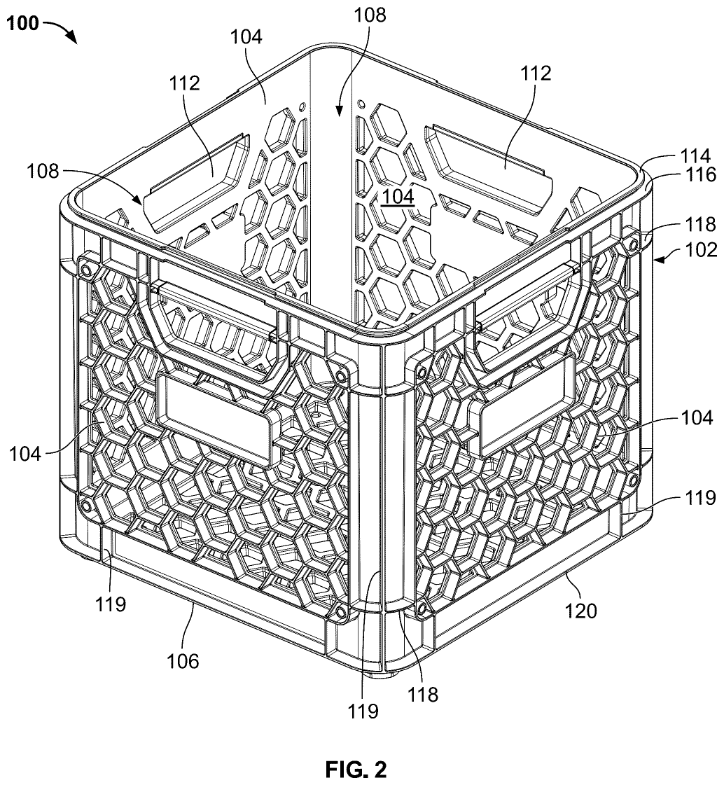

FIG. 2 depicts a perspective view of the crate 102 from FIG. 1 without a lid which can be configured for forming modular storage system 100, according to one or more aspects described herein. Crate 102 may include sides 104 having carry handles or grips 112. Sides 104 may form opening 108. Ridge 114 may be positioned at the uppermost portion of sides 104 and may be a continuous structure surrounding the upper perimeter of opening 108. In some examples, ridge 114 may be non-continuous, or a broken structure having gaps, for example, near the corners where sides 104 meet. Similarly, lip 116 may be positioned at the uppermost portion of sides 104 below ridge 114, and may be a continuous structure surrounding the upper perimeter of opening 108. In some examples, lip 116 may be non-continuous, or a broken structure having gaps, for example, near the corners where sides 104 meet. In some examples, ridge 114 and/or lip 116 may be configured to engage a lid and/or a lid locking system such as latch 111 as previously discussed. In other examples, ridge 114 and/or lip 116 may be configured to engage bottom 106 of another crate 102 for the modular stacking or positioning of multiple crates 102 in a vertical orientation.

As also depicted in FIG. 2, crate 102 may include various horizontal support structures 118 and vertical support structures 119 positioned on the exterior of sides 104. In some examples, horizontal support structures 118 and/or vertical support structures 119 may be positioned on the corners of crate 102 providing extra strength and rigidity to crate 102 and modular storage system 100. In some examples, crate 102 sides 104 may include bottom lip 120 positioned around the lower perimeter of crate 102, which also may provide extra strength and rigidity to crate 102. Bottom lip 120 may be configured to engage other attachments, accessories, and/or opening 108 of another crate 102, and/or ridge 114, and/or lip 116 of another crate 102 in order to secure one or more crates together in a modular system. It is also contemplated that the various support structures such as horizontal support structures 118, vertical support structures 119, and bottom lip 120 could be formed internally within the crate 102 or on one or more inside surfaces of the crate 102.

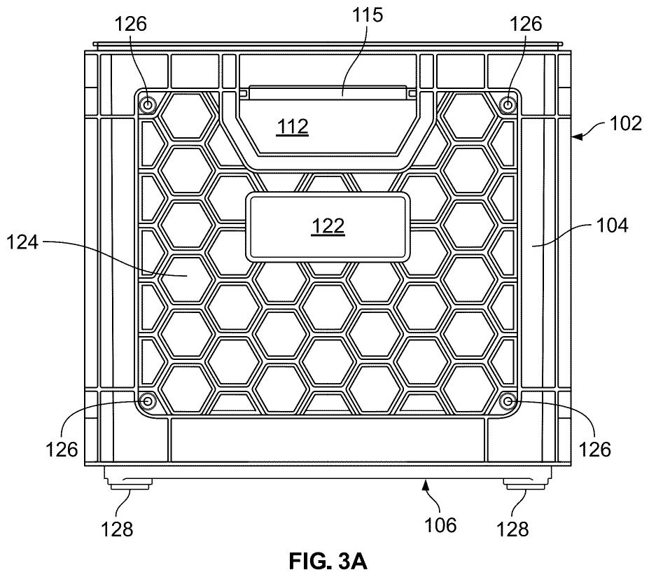

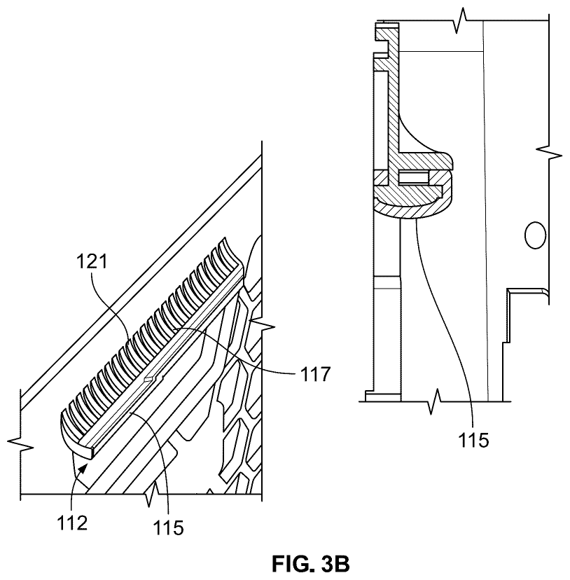

FIG. 3A depicts a side view of crate 102 without a lid for forming modular storage system 100, according to one or more aspects described herein. Crate 102 may include four sides 104, which in one example can be identical and symmetric where a cube shape is desired. Side 104 may include carry handle or grip 112. In some examples, at least two sides 104 may include a carry handle. In other examples, crate 102 may include at least four carry handles or grips 112 positioned on each side 104. In yet other examples, side 104 may include multiple carry handles or grips 112. Carry handle may include a grasping portion 115 in the form of a snap on assembly configured to engage a top portion of handle 112. Grasping portion 115 may be removably attached to handle 112. In this example the grasping portion can have a C cross-sectional shape and can be correspondingly shaped to the projection forming the handle 112. In other examples, grasping portion 115 may be permanently affixed to handle 112. In other examples, grasping portion 115 may be co-molded with handle 112. Grasping portion 115 may aid a user's grip while carrying crate 102, or provide additional comfort. Grasping portion 115 may be formed of silicone, neoprene, nitrile, polyvinylchloride, butyl rubber, rubber, polymer, composite, metal/alloy material, polycarbonate material, alternative polymeric materials and/or combinations thereof. As shown in FIG. 3B, carry handle or grip 112 may include wide crown extension 117 at the top of the grip that extends into the storage area of crate 102. The wide crown extension 117 portion that extends into the crate may also include a series of ribs or a ribbed portion 121 positioned on an upper portion of wide crown extension 117 such that a user gripping handle 112 can position their thumb on the series or ribs or ribbed portion 121 of wide crown extension 117 for increased friction on the gripping surface. In one example, the wide crown extension 117 may also more efficiently distribute the load across a user's fingers for case of lifting and carrying the crate 102. As also shown in FIG. 3B, grasping portion 115 may have a generally C-shaped profile or cross-section. It is also contemplated that the crate 102 could be configured to receive one or more straps for carrying the crate 102. The straps could be in the form of handles for hand carrying or shoulder straps for carrying the crate 102 on the user's shoulder. Moreover, one or more backpack straps are also contemplated.

As also shown in FIG. 3A, crate 102 may include a nameplate, name tag, or logo 122 positioned on side 104. Nameplate 122 may be on any one or all of the first, second, third, and fourth sides 104. In some examples, nameplate 122 may only be on two opposite sides 104. A logo or name may be molded or embossed directly into the material forming nameplate 122 and in one example the logo or name can extend entirely through the thickness of the material forming the nameplate 122. In other examples, nameplate includes Velcro® for the attachment of labels, titles, names, or other designs. In other examples, nameplate 122 may include one or more hook and loop fasteners, clasp fasteners, ties, or magnetic elements, among others for the attachment of objects.

As discussed above, crate 102 may include a series of feet affixed to bottom 106 and lower foot mount 128. In some examples, the feet are removably attached to lower foot mount 128. In some examples, lid retention areas or cutouts 113 positioned on or near the corners of lid 110 may be configured to engage the feet and/or lower foot mount 128 to facilitate vertical stacking of another crate 102. Retention areas or cutouts 113 may prevent a vertically stacked crate 102 from moving or shifting while stacked on a crate 102 having a lid 110. In other examples, lower feet mount 128 may be integrally formed with bottom 106. Crate 102 may further include a series of screw boss holes or ports 126 positioned near the upper and lower corners of sides 104. The series of screw boss holes 126 may be configured for the mounting of objects to crate 102 via mechanical fastener or press fit (e.g. peg). The series of screw boss holes 126 may also be configured for the mounting of crate 102 to objects via mechanical fastener or press fit (e.g. peg). The series of screw boss holes 126 may also be configured for the attachment to another adjacent crate 102 to form the modular storage system 100 or to another structure such as a wall, floor, or platform. In still other examples, injection feet may be configured to attach to the series of screw boss holes 126 on sides 104. In some examples, screw boss holes or ports 126 may be threaded or smooth and configured to mate with various types of fasteners such as screw, bolt, hex bolt, rivet, anchor, flange nuts, hex nut, cap nut, lock nut, socket screw, etc. Fasteners disclosed herein may include materials such as metals, alloys, polymers, plastics, etc. or combinations thereof. In other examples, the pattern of the series of screw boss holes may be the same on all sides 104. In still other examples, crate 102 may be attached to other crates, surfaces, walls, platforms, floors, etc. via one or more hook and loop fasteners, clasp fasteners, ties, magnetic elements, ferromagnetic elements, plastic or metal fasteners, threads, pegs, friction-fits, bayonet, threads, ball and socket, magnets, etc. and any other attachment methods discussed herein to form the modular systems disclosed herein.

These attachment methods and features can provide various mounting platforms that can be used in conjunction with the crate 102 or series of crates 102, which are also contemplated. For example, boards in the form of one or more sheets can be provided to receive one or more crates 102 for vertically or horizontally mounting one or more crates 102. In one example, the one or more sheets can include various mounting methods such as threads, pegs (pegboard), friction-fits, bayonet, threads, ball and socket, hook and loop, magnets, ferromagnetic, and any other attachment methods discussed herein can be used. In this example, the one or more sheets can include correspondingly oriented hole patterns to the ports of the series of crates 102 and can be used in conjunction with a series of crates so the series of crates can be mounted to the one or more sheets. The boards can be mounted together using any known permanent or non-permanent methods for modularity and customization by the user. Furthermore, it is contemplated that the crate and modular systems can be used in homes, offices, vehicles, and other structures as discussed herein.

In another example, the pattern of the series of screw boss holes may be the same only two opposite sides 104, with a different pattern of the series of screw boss holes on the remaining two sides 104. In yet another example, the pattern of the series of screw boss holes may be different on each side 104. As also shown in FIG. 3A, crate 102 may include a lattice comprising a matrix and interstitial space (e.g., voids) comprising a series of geometric shapes forming the structure of sides 104 and allowing visibility into crate 102, for example, to easily identify contents stored in crate 102 and to maximize airflow through crate 102. The geometric shapes may include, for example, trusses and/or a matrix with hexagon patterns, partial hexagon, or honeycomb patterns. Other geometric structures and patterns to form a lattice are contemplated to include octagons or other polygon shapes known in the art. Lattice structures, as disclosed herein, provide an efficient means to accommodate increased levels of stress and heavier loads via their incorporation in the design of modular storage system 100. The lattice structures as disclosed herein impart strength and flexibility to lightweight materials that may be used to fabricate modular storage system 100. The lattice structures as disclosed herein may also help to reduce the amounts of material used to form the crate 102 and series of crates 102 used to form the modular storage systems 100 for example as discussed herein.

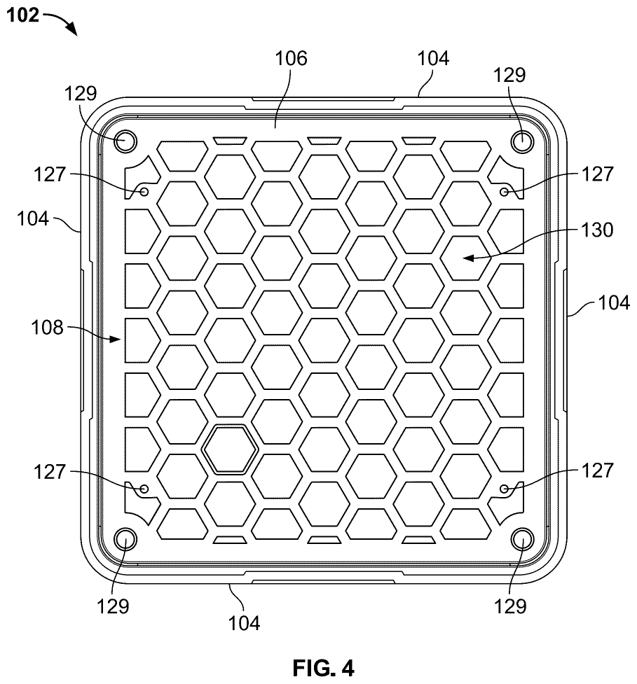

FIG. 4 depicts a top view of crate 102, according to one or more aspects described herein. Crate 102 may include sides 104 and bottom 106 that together form storage area 130. Storage area 130 may be configured to contain various objects, including both rigid and soft objects. The upper portions of sides 104 may form opening 108 configured to allow access to storage area 130. Bottom 106 may also include a series of bottom screw boss holes or ports 127. Bottom screw boss holes or ports 127 may be configured for the mounting of objects to crate 102 via mechanical fastener or press fit (e.g. peg), or for the mounting of crate 102 to objects via mechanical fastener or press fit (e.g. peg). The bottom series of screw boss holes or ports 127 may also be configured for the attachment to another crate 102 to form the modular storage system 100 or to secure to another structure such as a floor, deck, or other platform. In still other examples, feet (not shown) may be configured to attach to the series of bottom screw boss holes or ports 127. In some examples, as described above, bottom screw boss holes or ports 127 may also be threaded or smooth and configured to mate with various types of fasteners such as screw, bolt, hex bolt, rivet, anchor, flange nuts, hex nut, cap nut, lock nut, socket screw, etc. In other examples, the pattern of the series of bottom screw boss holes 127 may be different than the series of screw boss holes 126 positioned on sides 104. In another example, the pattern of the series of bottom screw boss holes or ports 127 may be the same as the pattern of the series of screw boss holes 126 positioned on sides 104. Bottom 106 may include upper foot mount 129 positioned in the corner portions of bottom 106. Upper foot mounts 129 may be formed integrally with bottom 106 and may provide additional reinforcement to feet affixed to bottom 106. In other examples, upper foot mount 129 may be removably attached to a port or orifice configured to removably engage injection feet (not shown).

As also shown in FIG. 4, bottom 106, like sides 104, may include a lattice comprising a matrix and interstitial space comprising a series of geometric shapes forming the structure of bottom 106. The geometric shapes may include trusses with hexagon patterns, partial hexagon, or honeycomb patterns as discussed herein. Other geometric structures and patterns to form a lattice are contemplated to include octagons or other polygon shapes known in the art.

FIG. 5 depicts a bottom view of crate 102, according to one or more aspects described herein. Crate bottom 106 may include, as discussed above, a series of bottom screw boss holes or ports 127. Again, screw boss holes or ports 127 may be configured to removably secure or affix a series of feet to bottom 106. Screw boss holes or ports 127 may also be threaded or smooth and configured to mate with various types of fasteners such as screws, bolts, hex bolts, rivets, anchors, flange nuts, hex nuts, cap nuts, lock nuts, socket screws, etc. As discussed above, the bottom series of screw boss holes 127 may also be configured for the attachment to another crate 102 to form the modular storage system 100 or to secure to another structure such as a floor, deck, or other platform. Injection feet or feet may be secured to bottom 106 via a fastener that may engage lower foot mount 128 positioned in the corners of bottom 106. The feet and/or fastener may also engage upper foot mount 129 positioned in the corner portions of bottom 106 and on a top portion of bottom 106, and above lower foot mount 128. Upper foot mount 129 may include a threaded or non-threaded orifice or foot secure point 132 that may transition through lower foot mount 128 and bottom 106. In some examples, lower foot mount 128 and upper foot mount 129 may be integrally formed with bottom 106.

As also shown in FIG. 5, bottom 106 may further include bottom ridge 134 and/or bottom lip 120. Bottom ridge 134 may be positioned at the lowermost portion of sides 104 and may be a continuous structure surrounding the lower perimeter of bottom 106. In some examples, bottom ridge 134 may be non-continuous, or a broken structure having gaps, for example, near the corners where sides 104 meet. As discussed above, bottom lip 120 may be positioned at the lowermost portion of sides 104 below bottom ridge 134, and may be a continuous structure surrounding the lower perimeter of bottom 106. In some examples, bottom lip 120 may be non-continuous, or a broken structure having gaps, for example, near the corners where sides 104 meet. In some examples, bottom ridge 134 and/or bottom lip 120 may be configured to engage an upper portion or top of crate 102 or opening of crate 102 or multiple crates 102 in a vertical orientation. Bottom lip 120 may be configured to engage other attachments, accessories, and/or opening 108 of another crate and/or ridge 114, and/or lip 116 of another crate 102.

FIGS. 6A and 6B depict a bottom-perspective view and a close up view of an alternative example crate 102 having reversible double injection feet 131, according to one or more aspects described herein. Feet 131 may be removably affixed to bottom 106 via lower feet mounts 128 and feet secure points 132. Feet fasteners 133 may removably engage feet 131 to foot secure points 132. As previously discussed, feet fasteners 133 may include materials such as metals, alloys, polymers, plastics, etc. or combinations thereof. In some examples, feet 131 can be mounted to the crate in two different configurations or orientations depending on the desired use of the crate. For example, the user may want the crate 102 to more easily slide across a surface such as a bedroom floor or other indoor surface, or the user may not want the crate to slide across a surface, for example the back of a pickup truck bed, boat deck, vehicle trunk, etc. Feet 131 may be reversible having a first side 131a consisting of a rubber or other elastomer that provides a gripping surface or an increased frictional surface (e.g., comprising an increased coefficient of friction) configured to keep crate 102 from unintended moving on a surface. The reversible or opposite side 131b may consist of a plastic or other polymer having a coefficient of friction less than 131a to allow crate 102 to be slideable across a surface. Foot 131 may be formed by double injection to form an integral reversable foot. In other examples, foot 131a/131b may be formed of separate components and joined by heat, welding, adhesive, fastener, or other method known in the art. Additionally or alternatively, foot 131 may comprise a first side having a first material, for example, plastic, other polymer or metal. The first material may comprise a first coefficient of friction. The foot 131 may comprise a second side substantially opposed to the first side. A material having a second, higher coefficient of friction (e.g., rubber) may be overshot over a portion (e.g., a first side 131a) of the foot 131, for example, over the second side. The resulting foot 131 may comprise a first side 131a having an increased coefficient of friction and a second side 131b (e.g., substantially opposed to the first side) having a decreased coefficient of friction. In some examples, foot 131 may be permanently affixed to bottom 106. In still another example, foot 131 may be integrally formed with bottom 106 and/or lower foot mount 128. In alternative configurations it is also contemplated that crate 102 could include wheels instead of feet or combinations of wheels and feet. In this example, the wheels may provide the user with case of moving the crate.

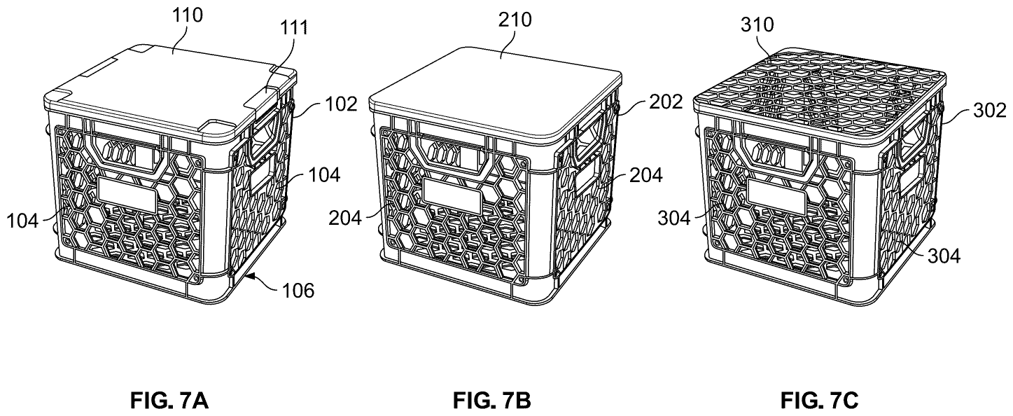

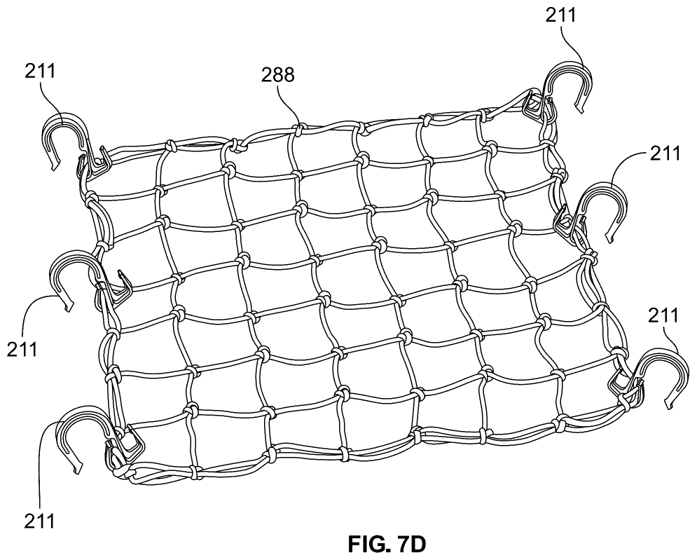

FIG. 7A depicts a perspective view of a crate 102 having lid 110 with latch 111, according to one or more aspects described herein. As discussed above, lid 110 may be configured to attach to the top of crate 102 to secure belongings or other objects within the crate storage area. Lid 110 may be configured to fit over or within the opening. Lid 110 may also include latch 111 configured to clamp onto sides 104. Latches 111 may be hingedly coupled to lid 110. Again, as discussed herein, the hinge of latches 111 may utilize one or more of flexure elements (e.g. a live hinges), or piano hinges, pegs or posts, among many others. In some examples, latches 111 may removably engage one or more lips or ridges positioned around the top perimeter of sides 104. When rotated downward, latch 111 may include a ridge or structure to engage the lips or ridges to secure the lid in a locked position. In one example, lid 110 may be configured to partially or wholly seal the opening of crate 102 when latch 111 is in a locked or secured position such that items cannot fall out of crate 102 in the event crate 102 is inverted. In still other examples, lid 110 may further include a gasket as described in the below paragraphs.

FIG. 7B depicts a perspective view of crate 202 having a press fit or friction fit lid 210 that may include a gasket (not shown), according to one or more aspects described herein. In this example, the lid 210 is configured to cover the opening of the crate 202. The lid gasket may extend around at least a portion of a lower internal or bottom perimeter of the lid 210. In other examples, the lid gasket may extend around the entire lower internal or bottom perimeter of the lid 210. In some examples, the gasket may be constructed as a singular, unbroken, continuous component. In another example, the gasket may be constructed with one or more breaks in the gasket or the lid may include multiple gaskets. The gasket may be configured to fit within the opening defined by the upper portion of sides 204. The gasket may be configured to seal the opening by press fit or friction fit with the opening. The gasket may be constructed from silicone, neoprene, nitrile, polyvinylchloride, or butyl rubber, or combinations thereof. In another example, the gasket may be configured to partially or wholly seal the opening of crate 202 such that items cannot fall out of crate 202 in the event crate 202 is inverted. In yet another example, lid 210 may further include latches 111 as previously discussed.

FIG. 7C depicts a perspective view of crate 302 having solid lattice lid 310, according to one or more aspects described herein. Lid 310 may be opaque or clear to allow a user to easily visualize the contents contained within crate 302. Lid 310 may also include a similar lattice structure as described above, to include a matrix and interstitial space plurality of hexagon-shaped structures or other polygon-shaped structures, such as octagons, other polygon shapes, or honeycomb patterns, or other shapes known in the art. In some examples, the lattice is formed in an underside of lid 310. Again, the lattice structures, as disclosed herein, provide an efficient means to accommodate increased levels of stress and heavier loads via their incorporation in the design of lid 310. The lattice structures as disclosed herein impart strength and flexibility to lightweight materials that may be used to fabricate lid 310. In certain examples, the lattice structure may be ventilated or open such as sides 304. In other examples, the lattice structure may be enclosed and integrally formed with lid 310 as shown in FIG. 7C. The lattice structures may help to also reduce the amounts of material used to form the lid 310 and to reduce the weight of the lid 310, while maintaining a sufficiently strong lid 310. Lid 310 may include the sealing gasket (not shown) described above, and/or may include latches 111 previously discussed. Lid 310 may be formed of materials such as polycarbonate, PMMA, acrylic, polyethylene terephthalate, amorphous copolyester, polyvinyl chloride, polyethylene, ionomer resin, polystyrene, combinations thereof, etc.

FIG. 7D depicts cargo net 288 or similar device that may be used to replace lid 110 to secure items within crate 102. Cargo net 288 may include plastic or metal hooks 211 to attach to the upper portion of sides 104 to cover the opening.

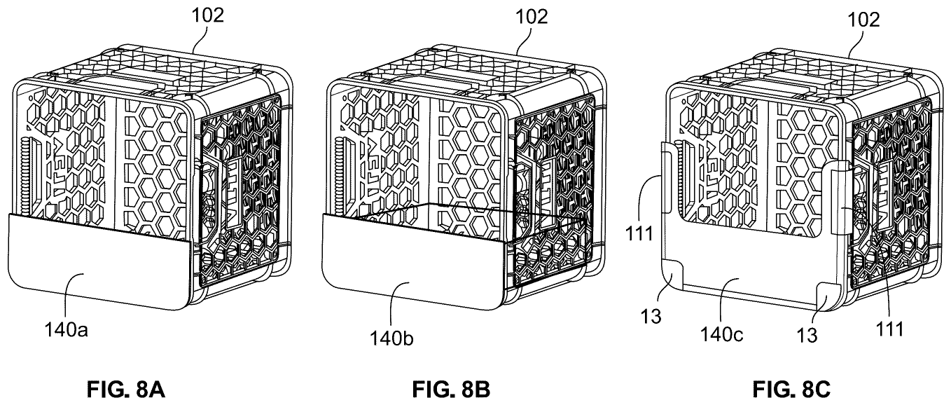

FIGS. 8A-8C depict examples of partial lids and drawer caddies for crate 102. As shown in FIG. 8A, partial lid 140a may be configured to secure a cover or portion of the opening of crate 102 to facilitate easy access to any items stored in crate 102. As shown in FIG. 8B, drawer caddy 140b may be configured in a tray or drawer like manner to hold objects or items that may be accessed by removing drawer caddy 140b from crate 102. As shown in FIG. 8C, partial lid or drawer caddy 140c may resemble a truncated or partial portion of lid 110 discussed above, and may include latches 111. Accordingly, with partial lid or drawer caddy 140c (and/or 140a) installed, crate 102 may be oriented on one of sides 104. The partial lid or drawer caddy 140a may simultaneously retain contents in crate 102 and enable/maintain easy access to the contents. Partial lids/drawer caddies 140a, 140b, and/or 140c may be constructed with any of the materials previously discussed. In other examples, partial lids/drawer caddies 140a, 140b, and/or 140c may be transparent or opaque similar to lid 310 as discussed above. In yet other examples, partial lids/drawer caddies 140a, 140b, and/or 140c may include sealing gaskets in accordance with the above description of lid 110 scaling gasket. As also shown in FIGS. 8A-8C, crate 102 may be rotated 90 degrees and mounted or affixed to objects or crates 102 such that the opening of crate 102 is oriented horizontally resembling a shelf or bureau. A user may easily reach into the storage area of crate 102 to retrieve personal belongings, clothes, or other objects. As discussed above, the series of screw boss holes or ports positioned near the upper and lower corners of sides 104 and corners of bottom 106 may be configured for the mounting crate 102 in a horizontal position as shown in FIGS. 8A-8C.

Also, as shown in relation to FIG. 8C, retention areas 113 may be provided on the partial lid or drawer caddy 140c. Accordingly, two crates having drawer caddy 140c can be placed in a back-to-back orientation, and a crate can be positioned on top of the two crates, such that the opening into the crates is accessible.

Additionally, it is also contemplated that the various sides or walls of the crate 102, for example, sides 104 and/or bottom 106, can be provided with one or more hinges (examples of which are discussed herein) to allow for the one or more sides, walls, or base to open to create alternate configurations.

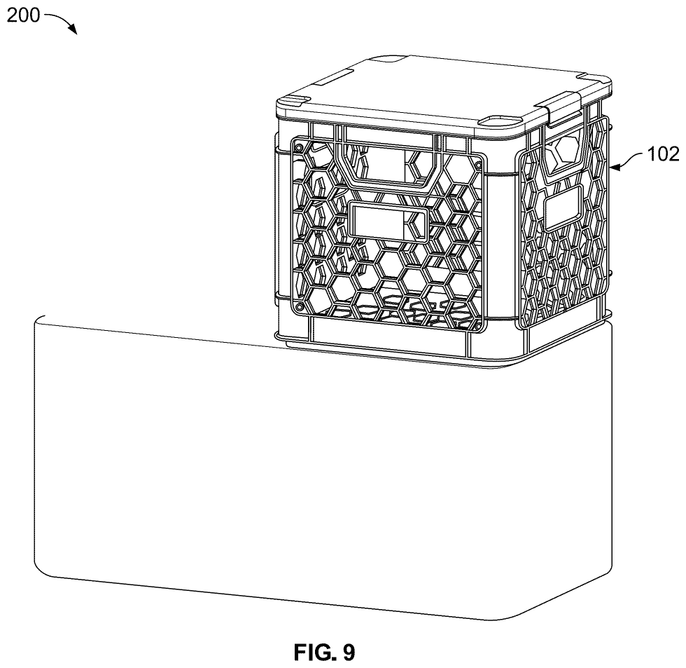

FIG. 9 depicts an alternative modular storage system 200 compatible with crate 102. It is contemplated that the various configurations of crate 102, as disclosed herein, may be compatible with other storage systems. Crate 102 may be configured as a modular component that may integrate with various fixed or transportable modular storage systems, cargo systems, or storage bin systems.

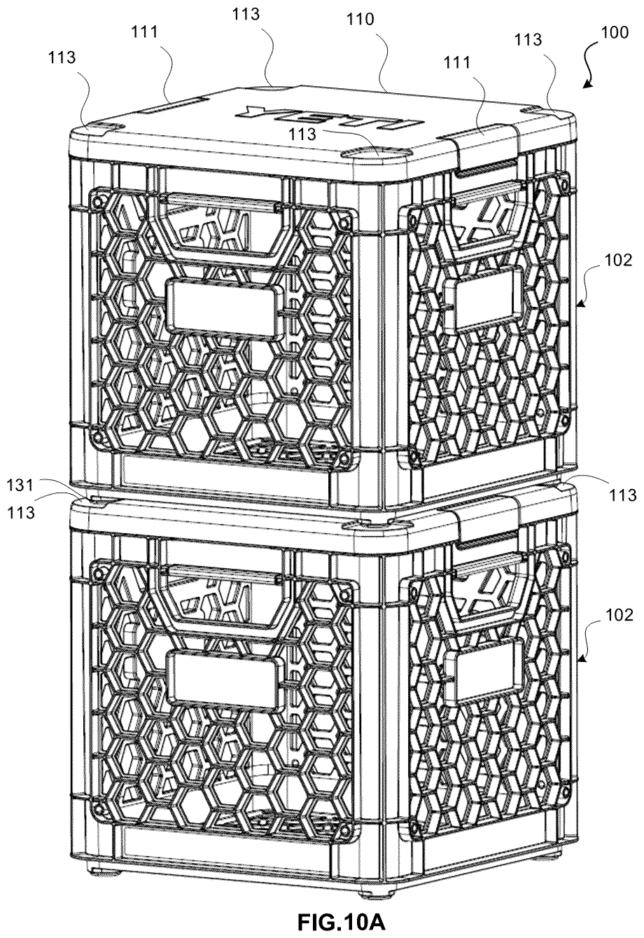

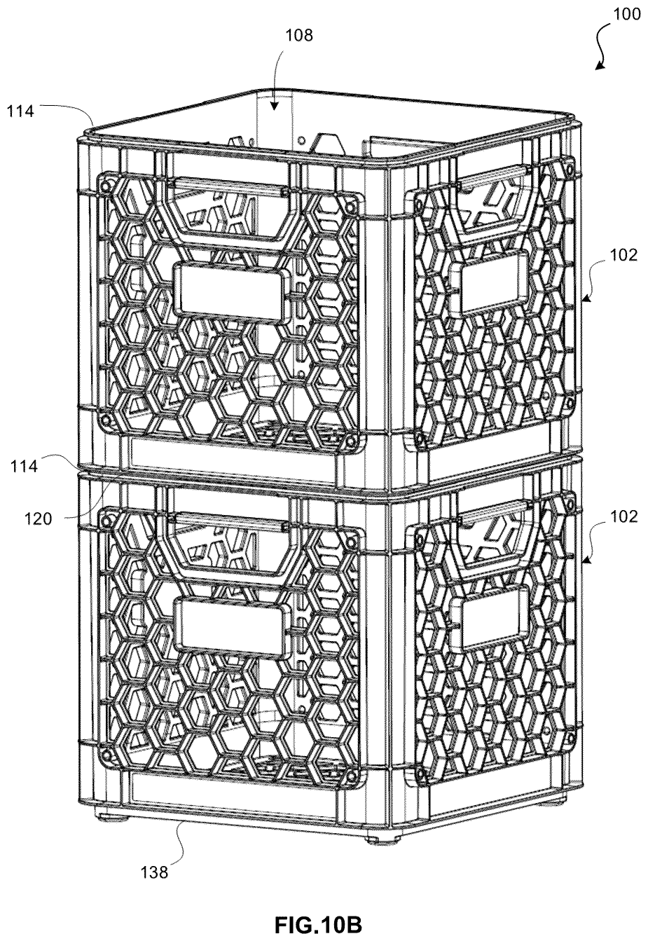

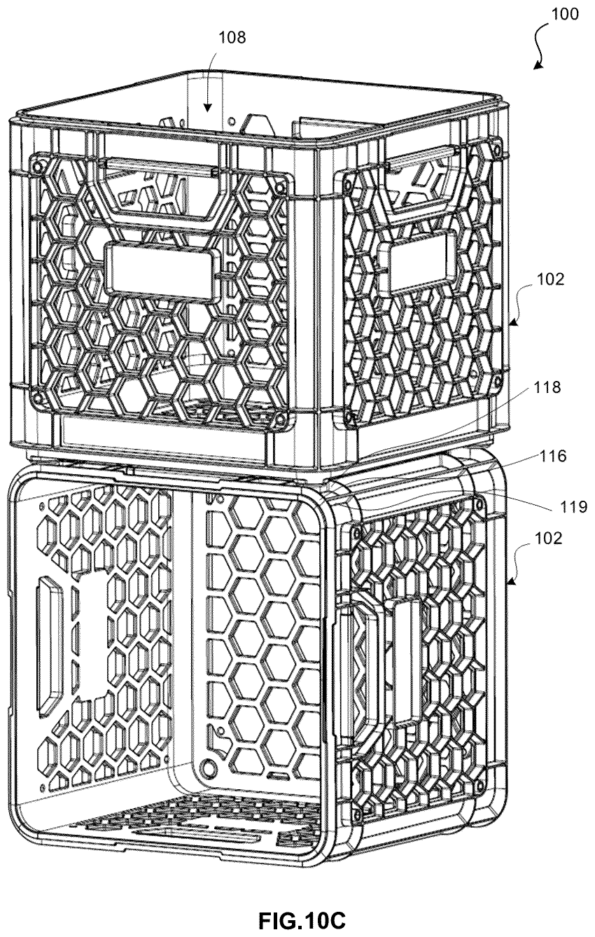

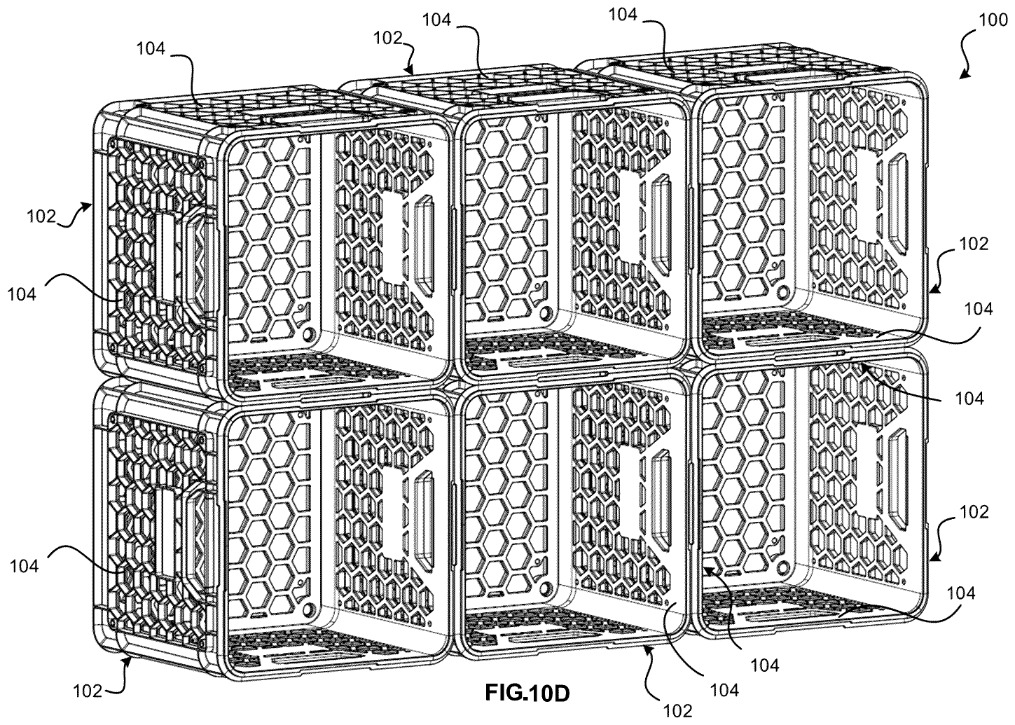

As described, modular storage system 100 may be variably configurable and stackable. FIG. 10A depicts an example of stacked crates 102 of modular storage system 100. Referring to FIG. 10A, one or more of a plurality of crates 102 may be covered (e.g., at opening 108) by lid 110. The plurality of crates 102 may be vertically stacked. For example, a first crate 102 may be stacked on a second, lower crate 102. The first crate 102 may be stacked on the lid 110 of the second crate 102. As described herein, lids 110 may comprise a series of cutouts 113. The feet 131 and/or lower foot mounts 128 of the first crate 102 may engage the cutouts 113 of the lid 110 on the second crate 102. For example, each foot 131 and/or lower foot mount 128 of the first crate 102 may engage a corresponding cutout 113 of the lid 110 of the second crate 102. Engagement of the feet 131 and/or the lower foot mounts 128 with the cutouts 113 may restrict relative movement (e.g., sliding) of the first crate 102 and the second crate 102. In this manner, the stacked crates 102 may be aligned, and relative movement may be restricted.

FIG. 10B depicts an alternative example of stacked crates 102 of modular storage system 100. FIG. 10A depicts an example configuration of stacked crates 102 comprising lids 110. Referring to FIG. 10B, crates 102 may be, additionally or alternatively, configured to be vertically stackable without lids 110. For example, as described herein, crates 102 may comprise a ridge 114, a bottom ridge 134, and a bottom lip 120. Crates 102 may be configured such that the bottom ridge 134 of a first (e.g., top stacked) crate 102 is complementarily mechanically configured with the ridge 114 of a second (e.g., bottom stacked) crate 102. Additionally or alternatively, a surface (e.g., an underside surface) of bottom lip 120 of the first crate 102 may engage (e.g., rest on) a surface (e.g., a top-side surface) of the ridge 114 of the second crate 102. Accordingly, crates 102 may be configured to be stackable such that the stacked crates are aligned and relative movement (e.g., lateral movement) is restricted without lids 110.

FIG. 10C depicts an alternative example of stacked crates 102 of modular storage system 100. Examples of vertically stacked crates 102 have been described. Crates 102 may, additionally or alternatively, be stacked differently. For example, referring to FIG. 10C, a first, upright crate 102 may be stacked on a second, sideways crate 102. The feet 131 and/or the lower foot mounts 128 (for example, as depicted in FIGS. 6A-6D) of the first, upright crate 102 may fit into a space between lip 116, a horizontal support structure 118, and two vertical support structures 119. Accordingly, crates 102 may be configured such that upright and sideways crates are stackable such that the stacked crates are aligned, and relative movement (e.g., lateral movement) is restricted. It will be appreciated that connector 442 described herein and/or screw boss holes/port (e.g., screw boss holes/port 126 and/or 127) may be used to further affix the first crate 102 to the second crate as described in more detail herein.

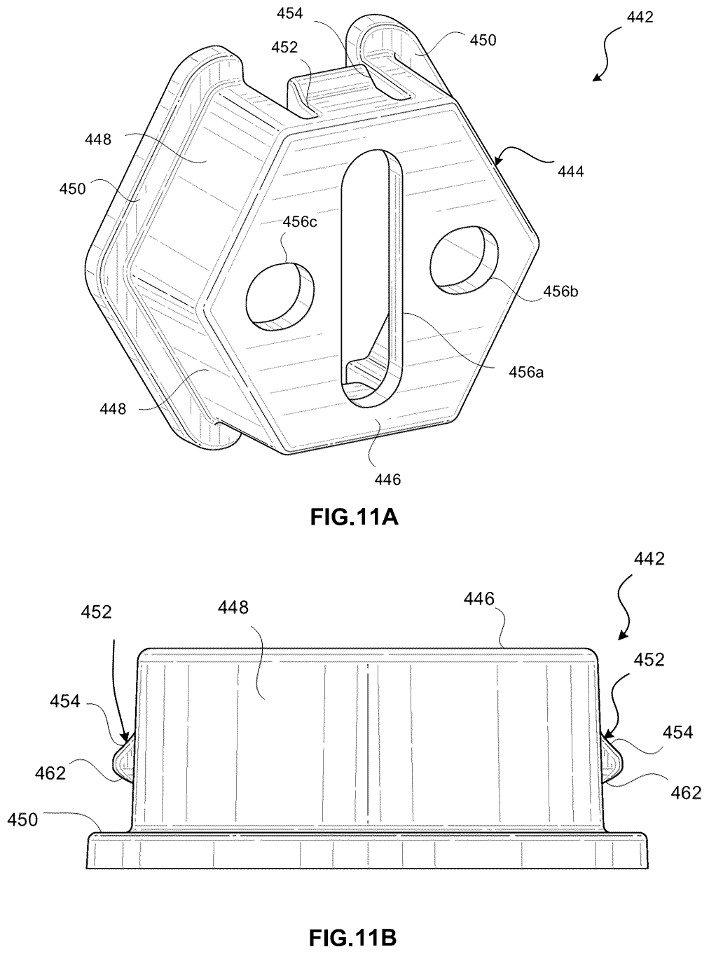

FIG. 10D depicts an alternative example of stacked crates 102 of modular storage system 100. Referring to FIG. 10D, a plurality of crates 102 may be side stacked. For example, the side 104 of a first, upper crate 102 may be stacked on a side 104 of a second, lower crate. Additionally or alternatively, a side 104 of a first lateral crate 102 (e.g., crate 102 to the left) may abut the side 104 of a second lateral crate (e.g., crate 102 to the right). It will be appreciated that connector 442 shown, for example, in FIGS. 11A and 11B and described herein and/or screw boss holes/port (e.g., screw boss holes/port 126 and/or 127) may be used to further affix side stacked crates 102 in various configurations as described in more detail herein.

Modular storage system 100 described herein may further comprise connectors 442. FIG. 11A depicts an example connector 442. Referring to FIG. 11A, the connector 442 may comprise a connector body 444. The connector body 444 may be substantially hexagonal shaped (e.g., comprising six sides and six vertices). The connector body 444 may be solid, substantially hollow or shelled. The connector body may comprise a base 446 and walls 448 extending from the base 446. The walls 448 may extend substantially vertically from the base 446. Additionally or alternatively, the walls 448 may be slanted and/or tapered (e.g., outwardly slanted and/or tapered) as they extend vertically from the base. In the example of FIG. 11A, walls 448 extend from four of the six sides (e.g., flat sides) of the hexagonal connector 442. In examples, the walls 448 may extend from only a portion (e.g., a subset) of the connector base 446 (e.g., and encircle a subset of the connector body 444 as depicted in FIG. 11A). Alternatively, walls 448 may extend from substantially the entire base 446 (e.g., and encircle substantially the entire connector body 444).

The connector 442 may further comprise a flange 450. The flange 450 may extend from one or more portions of the walls 448. The flange 450 may extend outward from the wall 448 away from a center of the connector 442. In some embodiments, the flange 450 may extend approximately orthogonally outward from the wall 448. The flange 450 may extend from a top portion of the walls 448. Additionally or alternatively, the walls 448 may extend beyond the flange 450. The flange 450 may extend from all portions of the walls 448 or from a subset of the portions of the walls 448. The flange 450 may be configured and/or used to retain the connector 442 in engagement with crate 102, for example, with the lattice of crate 102, as described in more detail herein.

The connector 442 may further comprise retainers 452 (e.g., anchors, inserts, etc.) The retainers 452 may be configured as snap-fit retainers (e.g., to snap-fit engage the lattice (e.g., the matrix) of crate 102, as described in more detail herein). The retainers 452 may be configured to secure the connector 442 to the crate 102. The retainers 452 may extend (e.g., vertically) from the base 446. The retainers 452 may be outwardly slanted as they extend vertically from the base 446. The retainers 452 may be cantilevered from the base 446. The retainers 452 may be configured to be substantially elastically deformable. For example, the retainers 452 may be configured to elastically deform/deflect towards and away from a central axis (e.g., longitudinal axis) of the connector body 444. The retainers 452 may comprise a first sloped surface 454 (e.g., sloped horizontally or outward). The sloped surface may be configured to engage crate 102, for example, the lattice (e.g., the matrix) of crate 102, for example, upon installation of the connector 442 with crate 102, to deflect the retainers 452 and effectuate the snap-fit retention/engagement of the connector 442 with the crate 102, as described herein.

Connector 442 may further comprise one or more fastener points 456 (e.g., mounting points, attachment points, connection points, fixation points, bolt holes, screw holes, etc.). FIG. 11A depicts three fastener points 456a, 456b, and 456c (generally referred to as fastener points 456). Fastener points 456 may comprise apertures in the base 446 and through connector body 444. Fastener points 456 (e.g., apertures) may be substantially slotted, rounded, or otherwise shaped (e.g., oblong, parallelogram, etc.). Fastener points 456 may be variously configured in the connector body 444. The example configuration depicted in FIG. 11A comprises three fastener points 456-a slotted fastener point 456a extending between two hexagon sides (e.g., between two opposing hexagon sides), and two oblong fattener points 456b and 456c, each disposed between the slotted fastener point and a vertex of the hexagon connector body 444. Such an arrangement may account for adjustability and security of attachment. For example, the pattern of fastener points 456 (e.g., depicted in FIG. 11A) may be configured to provide a plurality of mounting arrangements, for example, for mounting various accessories as described herein. Additionally or alternatively, the two oblong fastener points 456b and 456c may be replaced by a second slotted fastener point 456 (e.g., substantially perpendicular to and bisecting with the first slotted fastener point 456a. Additionally or alternatively, one or more of the oblong fastener points 456b and 456c may be substantially round, square or otherwise shaped. Additionally or alternatively, the slotted fastener point 456a may be substituted for one or more (e.g., two or three) round or oblong fastener points 456. Fastener points 456 may be variously distributed over the connector base 446. The fastener points 456 may accept fasteners (e.g., threaded fasteners, screws, bolts, socket cap screws, press-fit pins, snap-fit pins, interference-fit pins, etc.). Accordingly, and as described in additional detail herein, connector 442 may be connected with crate 102 (e.g., via the snap-fit retainers 452), and fastener points may be used to affix one or more components to the connector 442 and/or affix the connector 442 to one or more components.

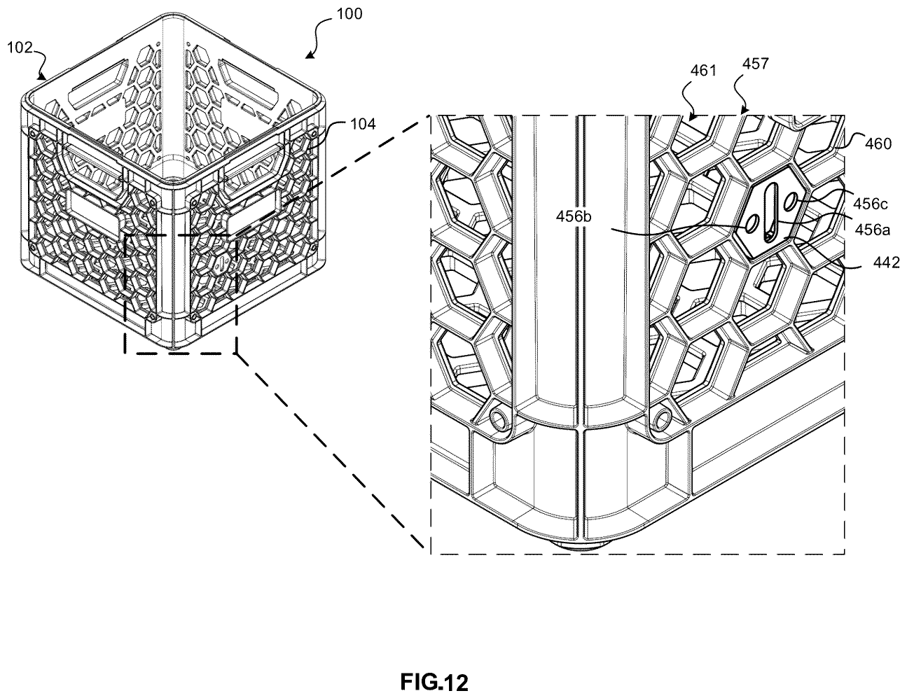

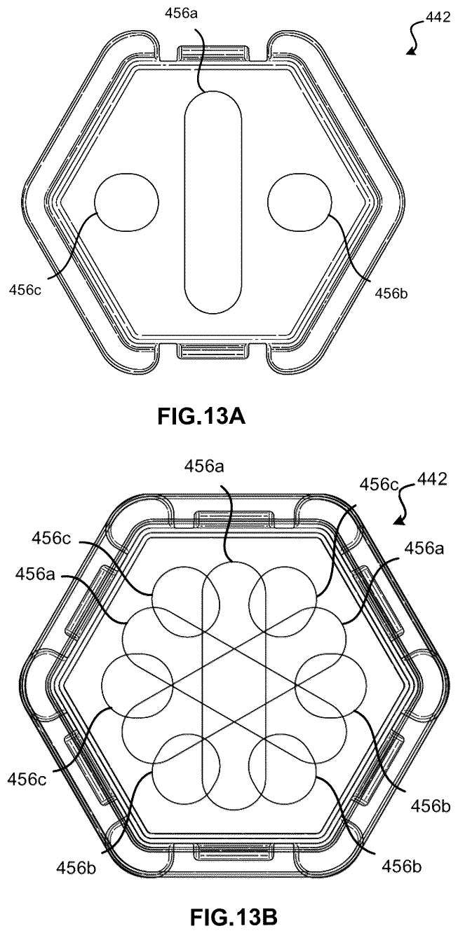

FIG. 12 depicts a connector 442 engaged with crate 102. As described herein, crate 102 may comprise a lattice (e.g., on the sides 104, bottom 106, and/or lid 110) comprising a series of geometric shapes. The geometric shapes may comprise a matrix (e.g., material) and voids (e.g., interstitial space) in the lattice. The geometric shapes may include, for example, trusses with hexagon patterns, partial hexagons, or honeycomb patterns. Other geometric structures and patterns to form a lattice are contemplated to include octagons or other polygon shapes. Lattice structures, as disclosed herein, may provide an efficient means to accommodate increased levels of stress and heavier loads via their incorporation in the design of modular storage system 100.

With continued reference to FIG. 12, the modular storage system 100 may comprise one or more connectors 442. Connector 442 may be configured to fit into the interstitial space (e.g., voids) of the lattice. Accordingly, connector 442 may be shaped similarly to the geometric shapes of the lattice. For example, referring to FIG. 12, the connector 442 may be hexagonally shaped. Alternatively, connector 442 may be shaped to correspond and/or be complimentary to the lattice (e.g., trusses and/or voids). The lattice (e.g., lattice structure, trusses and/or voids) and a portion of the connector 442 may be configured to, for example, interference fit, clearance fit, press fit, slip fit, friction fit, and/or geometric fit. As described herein, connectors 442 may be used to 1) connect crate 102 to various structures, 2) connect two or more crates 102, and/or 3) connect one or more accessories to crate 102. Connectors 442 may be formed of materials such as, for example, polymers, composites, metal/alloy materials, polycarbonate materials, alternative polymeric materials, etc.

With continued reference to FIG. 12, the lattice structure (e.g., matrix and/or trusses) of crate 102 may comprise a substantially ‘T’ shaped cross-section. Accordingly, the lattice structure may be understood to comprise a web 458 (e.g., stem) and lattice flanges 460 (e.g., crossbar). The lattice structure may comprise voids or interstitial space (e.g., in the matrix) between the web 458 and lattice flanges 460. To install the connector 442 to the crate 102, the connector body 444 (e.g., the base 446) may be inserted into the interstitial space in the lattice structure, for example, such that the walls 448 of the connector 442 extend into the interstitial space. The connector 442 may be inserted from the outside of the crate 102 or from the inside of crate 102. Upon continued insertion, the lattice flanges 460 may engage the retainers 452. For example, the lattice flanges 460 may engage the first sloped surface 454 of the retainers 452.

Engagement of the lattice flanges 460 and the retainers 452 may exert a force to deflect and/or deform (e.g., elastically deform) the retainers 452, for example, from a neutral or equilibrium position. Upon continued insertion, the retainers 452 may clear the lattice flanges 460 and snap back toward the neutral position (e.g., in the direction of adjacent web 458). Accordingly, the lattice flange 460 may be engaged, on a first side, between a face of the retainers 452 and, on a second opposite side, the connector flange 450. Accordingly, engagement of the retainers 452, the connector flange 450 and the lattice flange 460 may act to retain the connector 442 in installed engagement with the crate 102. In an example configuration, the connector flanges 450 and the lattice flanges 460 may comprise one or more holes. Upon installation of the connector 442 to the crate 102, the one or more holes of the lattice flanges 460 may align with the one or more holes of the installed connector flanges 450. Fasteners (e.g., screws, nuts and bolts, etc.) may be installed in the aligned holes. In such a configuration, the connection between the connector and the crate may be strengthened.

FIG. 13A depicts a front view of the example connector 442 of FIGS. 11A and 11B. FIG. 13B depicts three illustrations of the example connector 442 of FIG. 13A rotated by about 60° and overlaid. As can be appreciated and described herein, connector 442 may be connected with crate 102 (e.g., via the snap-fit retainers 452) and fastener points 456 may be used to affix one or more components (e.g., a second crate 102, a second connector 442, an accessory) to the connector 442 and/or affix the connector 442 to one or more components. Referring to FIGS. 13A and 13B, as described, the fastener points 456 may be disposed on the connector 442 in a pattern configured to provide a plurality of mounting arrangements, for example, for mounting one or more accessories. As described, the connector 442 (e.g., hexagonally-shaped connector) may be mounted to the correspondingly shaped (e.g., including hexagonally-shaped portions) lattice structure. The connector 442 may be engaged with and/or mounted to the lattice structure in any of various orientations. For example, in the example configuration of a hexagonally-shaped connector and corresponding lattice, structure, the connector 442 may be engaged with and/or mounted to the lattice structure in any of six orientations. For example, the example hexagonally-shaped connector 442 may be mounted to the lattice structure at rotations of about 60°. The different mounting orientations of the connector 442 to the lattice structure may allow for various mounting point orientations as depicted by the overlay of the about 60° rotated connector 442 in FIG. 13B. It can be appreciated, with reference to FIGS. 13A and 13B, that the pattern of the fastener points 456 (e.g., as depicted and described in relation for FIG. 11A) may be configured to enable increased fastener point 456 options/coverage while ensuring strength of the connector 442. For example, the configuration of the fastening points 456 may be configured to provide two fastening points 456 on two substantially orthogonal axes, and a fastening point substantially at the center of the two orthogonal axes. Additionally, the fastening point 456 configuration may allow for material (e.g., material of the connector 442) in between the mounting points 456 (e.g., between mounting points 456a, 456b, and 456c) for improved strength and stability. Thus it can be appreciated that fastener points 456 configuration may provide increased mounting options and configurations while maintaining the strength of the connector.

FIG. 11B depicts an alternate view of the example connector 442 of FIG. 11A. Referring to FIG. 11B, as described, the retainers 452 may comprise a first sloped surface 454. The connector 442 may further comprise a second sloped surface 462. If installed with the crate 102, the second sloped surface 462 may substantially face, engage, and/or abut the lattice flanges 460. The second sloped surface 462 may be configured such that a force drawing the connector 442 away from the lattice (e.g., a force to remove the connector 442) may cause the second sloped surface 462 to engage the lattice flanges 460. Similar to that which is described in relation to engagement of the first sloped surface 454 and the lattice flanges 460 upon installation, engagement of the second sloped surface 462 and the lattice flanges 460 (e.g., upon a removal force) may cause the retainers to deflect away from the neutral position, allowing the connector 442 to be removed/uninstalled from the crate 102. The second sloped surface 462 may be configured such that a particular force may be operational to deflect the retainers 452, for example, allowing for the removal of the connector 442. In one example configuration, the first and second sloped surfaces 454 and 462 may be configured such that a lesser force is operational to deflect the retainers 452 upon installation and a greater force is operation to deflect the retainers 452 upon removal. The first sloped surface 454 may comprise a first angle of inclination (e.g., a lower gradient), and the second sloped surface 462 may comprise a second angle of inclination. In an example configuration, the first angle of inclination may be lower than the second angle of inclination. The angle of inclination of the first sloped surface 454 and/or the second sloped surface 462 may be adjusted higher or lower to affect the operational force to install and/or remove the connector 442. Additionally or alternatively, the retainers 452 may configured such that, once installed, an external force may be used to deflect the retainers 452 to allow the connector 442 to be removed from the crate 102.

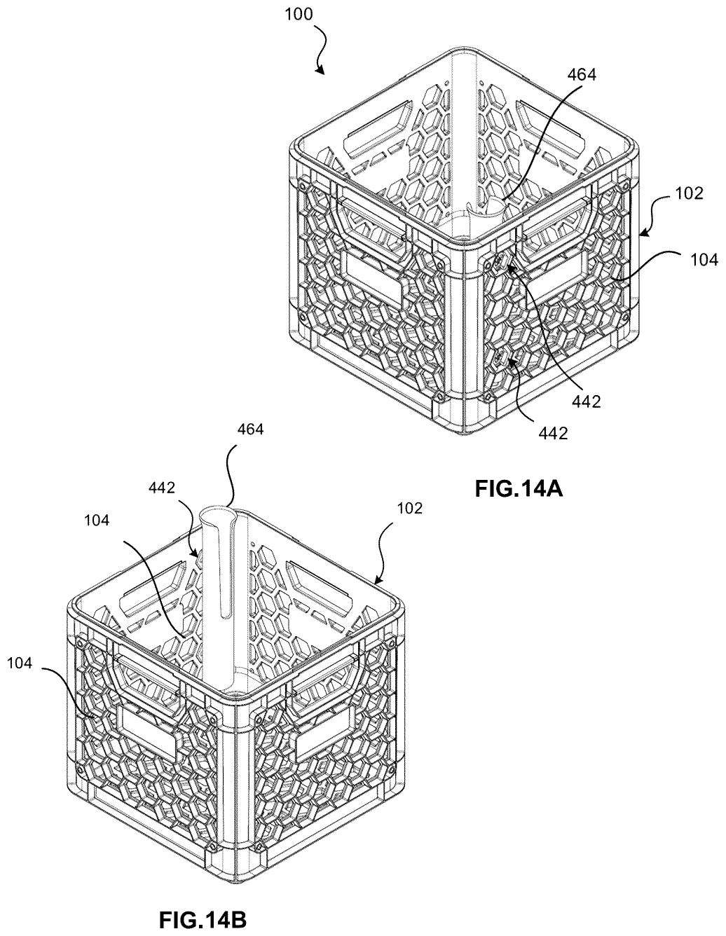

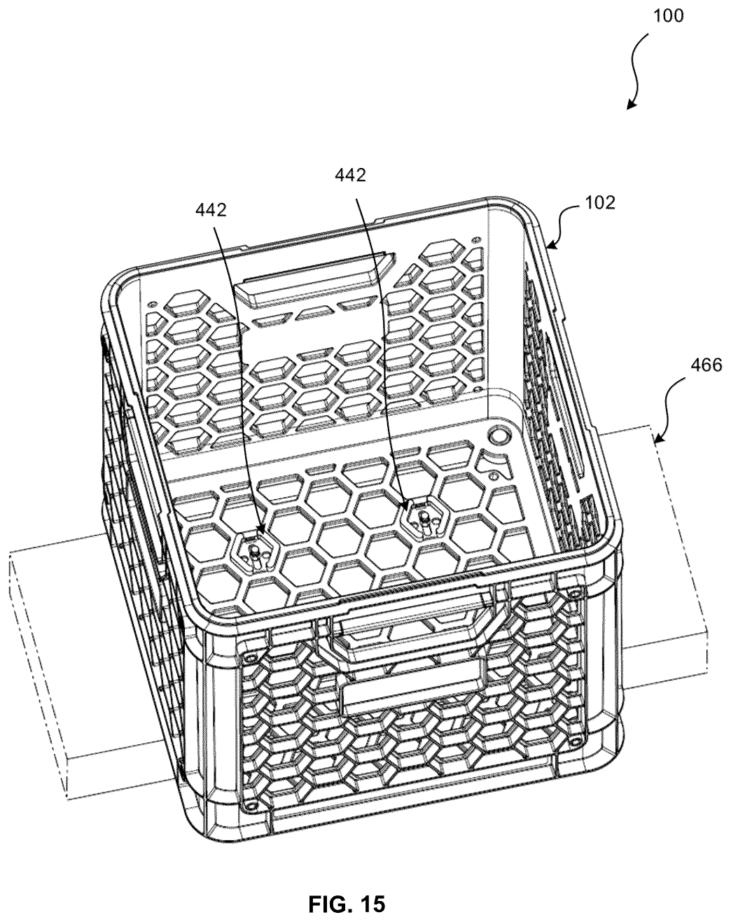

As can be appreciated, the connectors 442 may be used to 1) connect crate 102 to various structures, 2) connect two or more crates 102, and/or 3) connect one or more accessories to crate 102. FIGS. 14A and 14B depict example connectors 442 engaged with an example crate 102 and a fishing rod holder accessory 464. FIG. 15 depicts example connectors 442 engaged with an example crate 102 and a support surface. Referring to FIGS. 14A, 14B, and FIG. 15, one or more connectors 442 may be installed to the crate bottom 106 and/or crate sides 104 (e.g., the lattice structure of crate bottom 106 and/or sides 104). The fastener points 456 may be used (e.g., with fasteners and/or clamps, etc.) to affix the connector 442 to various structures, for example, bicycles (e.g., bicycle basket holders, bicycle rack surface, etc.), cars (e.g., roof racks), shelving, etc. Additionally or alternatively, one or more connectors 442 may be mounted (e.g., via fastener points 456) to a surface 466, for example, a wall (e.g., a garage wall), a truck bed, etc. Crates 102 may be subsequently engaged with and installed (e.g., at bottom 106 or sides 104) to the mounted one or more connectors 442. In such a manner, connectors 442 and crates 102 may be used to create simply removable/replaceable shelving and/or storage.

Additionally or alternatively, one or more connectors 442 may be installed to the crate bottom 106 and/or sides 104 (e.g., the lattice structure of crate bottom 106 and/or sides 104). The fastener points 456 may be subsequently used (e.g., with fasteners and/or clamps, etc.) to attach to one or more accessories 464. As non-limiting examples, such accessories 464 may include, for example, a fishing rod holder, a cup holder, a crate shelf, a crate shelf support (e.g., to support a removable shelf in crate 102), a crate divider, a crate divider support, bag hooks, mobile phone mount, light mount, etc.

Additionally or alternatively, connector 442 may be used to connect two or more crates 102 (for example, in example configurations depicted in FIGS. 10A-10D, and other configurations). For example, a first connector 442 may be installed to a first crate 102 (e.g., at bottom 106 or sides 104. A second connector may be connected to a second crate 102 (e.g., at bottom 106 or sides 104). The first and second connectors may be affixed to each other, for example, via corresponding fastener points 456. Additionally or alternatively, connector 442 may be configured as a crate connector. For example, the example connector depicted in FIG. 11A may be modified to be substantially mirrored about the flange face. For example, the connector may comprise a first base 446 at a first side and a second (e.g., substantially identical) base 446 at a second, opposed side. Retainers 452 and walls 448 may extend from each base (e.g., substantially as described herein). Both sets of walls may terminate in a central flange 450. Accordingly, the crate connector may be attached to a first crate 102 at its first end and to a second crate 102 at its second end. In these manners, connectors 442 may be used to connect crates in various configurations (e.g., side 104 to side 104, bottom 106 to side 104, bottom 106 to bottom 106, lid 310 to side 104, etc.). Additionally or alternatively, in these manners, crates 102 can be connected together around structures, for example, around a wheel well in a truck bed.

Additionally or alternatively, connector 442 may be configured as a cluster connector. A cluster connector may comprise a plurality of connectors 442 (e.g., as depicted in FIGS. 11A and 11B and FIGS. 13A and 13B) arranged with shared sides. Cluster connectors 442 may comprise a plurality of connector bodies (e.g., the walls and bases of a plurality of connectors 442) (e.g., a plurality of connector prongs) extending from the same flange and/or flange network. In such a manner, the cluster connector flange may be understood to comprise a flange network corresponding to a portion of the crate 102 lattice, and the cluster connector body portions may be configured to extend into a plurality of interstitial spaces of the crate lattice. Such a cluster connector may provide more areas of connector crate 102 engagement. Such cluster connectors may be advantageous, for example, in higher force applications.

Advantageously, the crate 102 and connector 442 may be leveraged to create connections with increased case of removability/attachment or connections with increased permanence. For example, an accessory may be affixed (e.g., via fastener points 456) to the flange side of the connector 442. Subsequently, the connector 442 and accessory may be installed and removed (e.g., snap-fit installed and removed), for example, without detaching the accessory from the connector 442. Such a connection may facilitate increased case of removability and attachment. Alternatively, the connector 442 may be installed to the crate 102. Subsequently, an accessory may be connected to the base side of the connector 442 (e.g., via faster points 456). With such a configuration, the accessory may require removal from the fastener points 456 of the connector 442 in order to remove the accessory (and connector 442) from the crate 102. Such a configuration may be associated with increased permanence.

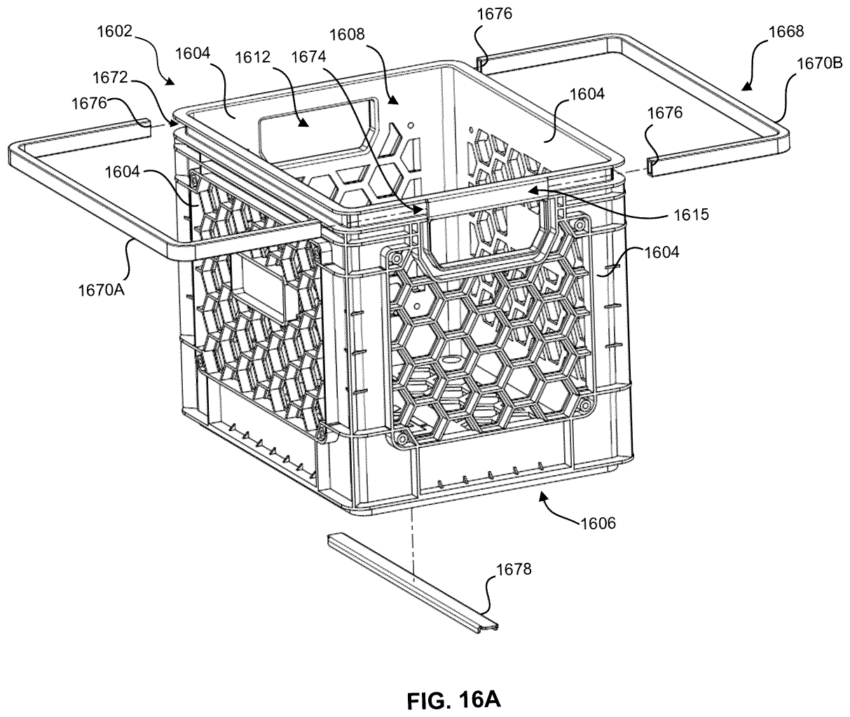

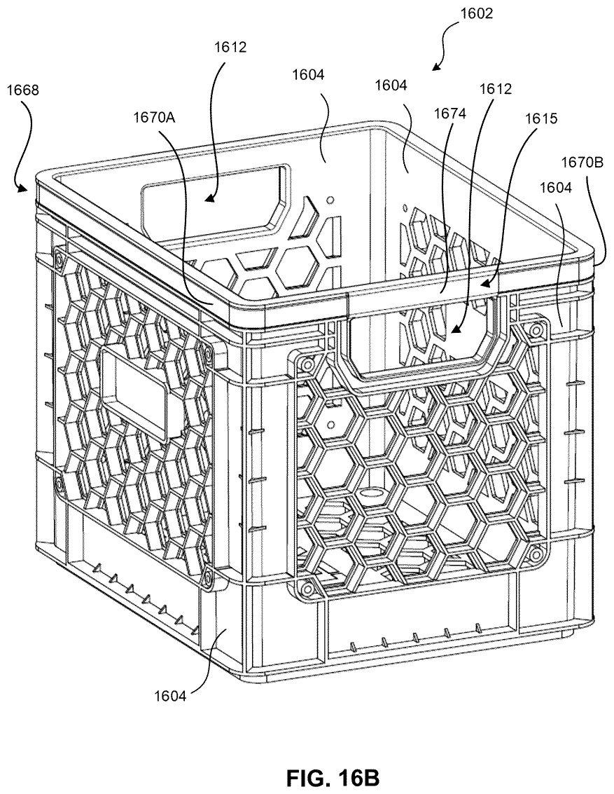

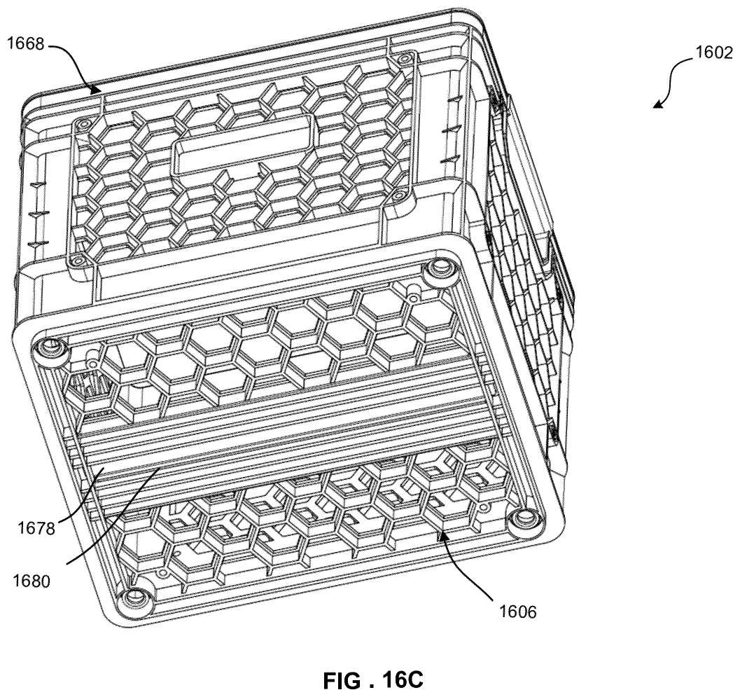

FIG. 16A depicts an example modular storage system 100 including a crate 1602 having a band 1668. The crate 1602 of FIG. 16A may be substantially similar to other crates described herein (e.g., crate 102, crate 202, and/or crate 302 of FIGS. 1-15) unless as described otherwise with respect to crate 1602. The crate 1602 may include a band 1668. The band 1668 may be configured to extend substantially around a perimeter of (e.g., circumscribe) the crate 1602, for example, proximate to a top of the sides 1604 of the crate 1602. The band 1668 may comprise two band portions of halves 1670 (e.g., first band half 1670A and second band half 1670B, generally, band half/band halves 1670). Each band half 1670 may be shaped and configured substantially corresponding to one half of a perimeter of the crate 1602, for example, proximate to a top of the sides 1604. Each band half 1670 may be substantially U-shaped. Each band half 1670 may comprise two ends 1676. The band 1668 may be formed of metal. The band 1668 may comprise a metal tube. For example, the band 1668 may comprise a hollow metal tube having tube walls. For example, the band 1668 may comprise an aluminum (e.g., anodized aluminum) tube. The band 1668 may comprise a substantially rectangular cross-sectional profile. The band 1668 may be configured to have an increased moment of inertia about the horizontal axis. Alternatively, the band 1668 may be configured to have an increased moment of inertia about the vertical axis. The band 1668 may be configured to reinforce the opening 108 and/or sides 1604 of the crate 1602.

The band 1668 may be installed to the crate 1602. For example, the crate 1602 may include a channel 1672. The channel 1672 may be formed in the sides 1604 of the crate 1602. The channel 1672 may be formed in the crate 1602 proximate to a top of the sides 1604. The channel 1672 may extend around all four sides 1604 of the crate. The channel 1672 may be configured to receive the band 1668. For example, the channel 1672 may be complementarily configured to receive the band 1668 (e.g., the two band halves 1670). Portions of the channel 1672 may be open, and other portions of the channel 1672 may be closed. Alternatively, the entire channel 1672, for example, configured to receive the band 1668, may be an open channel.

Similar to those described elsewhere herein, the crate 1602 may comprise one or more handles 1612. The handles 1612 may include a grasping portion 1615. The channel 1672 may extend through the grasping portion 1615. The channel 1672 may be closed on substantially four sides in the area of the grasping portion 1615, for example, comprising a conduit section 1674 of the channel 1672 in the area of the grasping portion 1615. As the channel 1672 is fully enclosed in the area of the grasping portion 1615, the handle may be more comfortable to carry the crate 1602 as edges and voids in structure formed by the channel 1672 and the band 1668 are not present. Alternatively, the entire channel may comprise three sides, for example, including in the area of the grasping portion 1615.

In use, the first band half 1670A may be engaged with (e.g., installed to) the crate 1602. The two ends 1676 of the first band half 1670A may be installed (e.g., slid into) a corresponding conduit section 1674 of the grasping portion 1615. The first band half 1670A may be seated in the channel 1672. Similarly, the second band half 1670B may be engaged with (e.g., installed to) the crate 1602. The two ends 1676 of the second band half 1670B may be installed (e.g., slid into) a corresponding conduit section 1674 of the grasping portions 1615. The second band half 1670B may be seated in the channel 1672. The ends 1676 of the first band half 1670A and the ends 1676 of the second band half 1670B may substantially meet and be joined. In one example configuration, the first band half 1670A and the second band half 1670B may meet and be joined in the conduit sections 1674. The conduit sections 1674 may therefore cover a joint between the first band half 1670A and the second band half 1670B. In alternative configurations (e.g., configurations having a fully open channel), the ends 1676 of the first band half 1670A and the ends 1676 of the second band half 1670B may substantially meet and be joined at any side 1604 of the crate 1602.

The first band half 1670A and the second band half 1670B may be mated to each other, for example, in the conduit sections 1674 (as described in more detail herein). The mated band halves 1670 may comprise the band 1668. The mated band halves 1670 (e.g., the band 1668) may provide reinforcement, rigidity, and/or stability to the crate. The mated band halves 1670 (e.g., the band 1668) may provide reinforcement, rigidity, and/or stability to the crate, for example, at a top of the sides 1604 and/or the opening 1608. Additionally or alternatively, the band 1668 may provide load distribution, for example, distributing the load of the crate 1602 if carried by the handles 1612, around the perimeter of the crate 1602 via the band 1668 and the channel 1672. The band 1668 may provide rigidity and strength to the handles 1612 and grasping portions 1615. The provided rigidity and strength of the band 1668 to the handle 1612 and grasping portions 1615 may allow forgoing of additional strengthening structures and configurations to the grasping portions 1615. Accordingly, the band 1668 may enable the production of the grasping portion 1615 with a reduced profile and/or smooth surface, while strengthening the grasping portion 1615, thereby improving the comfort, usability, and/or durability of the handles 1612 and grasping portions 1615.

While FIG. 16A depicts a crate 1602 having a substantially square cross-sectional profile, it should be appreciated that features related to the band 1668 may be practiced with alternative shaped crates (e.g., rectangular, circular, etc.).

With continued reference to FIG. 16A, the crate 1602 may further include a bottom 1606 and a bottom support 1678. The bottom support 1678 may be formed of metal, for example, aluminum, steel, etc. The bottom support 1678 may comprise a C-channel support. The bottom support 1678 may be engaged with the bottom 1606 (e.g., as described in additional detail in relation to FIG. 16C). If engaged with the bottom 1606, the bottom support 1678 may provide rigidity and strength to the bottom. Additionally, the bottom support 1678 may be operational to distribute a load on the bottom 1606. The bottom support 1678 may assist in preventing deformation of the bottom 1606 under load.

FIG. 16B shows a first view of the crate 1602 of FIG. 16A with the band installed. Referring to FIG. 16B, the band 1668 may substantially traverse a perimeter of the crate 1602. In the example configuration of FIG. 16B, the two band halves 1670 meet in the conduit section 1674 of the grasping portion 1615. Alternatively, instead of the conduit section 1674, the grasping portion 1615 may comprise an open channel section. The band halves 1670 may be installed to the crate such that the band half ends (e.g., ends 1676 of FIG. 16A) meet at any of the sides 1604 of the crate. Additionally, the band 1668 may provide a surface for personalization. For example, the band 1668 may be customized via, for example, laser engraving, pad printing, and/or screen printing.

FIG. 16C shows an alternative view of the crate 1602 of FIGS. 16A and 16B with the band 1668 and bottom support 1678 installed. Referring to FIG. 16C, the crate 1602 may include a track 1680. The track may be formed in the bottom 1606 of the crate 1602. The track 1680 may be configured to receive the bottom support 1678. The bottom support 1678 may be installed to the track 1680 to provide the rigidity, strength, load distribution, and deformation prevention to the bottom or base 1606.

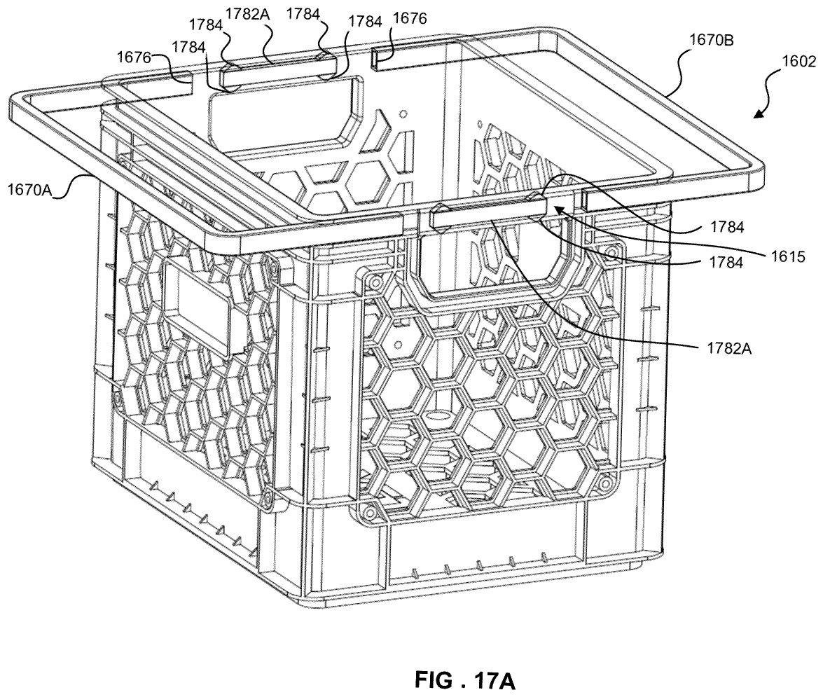

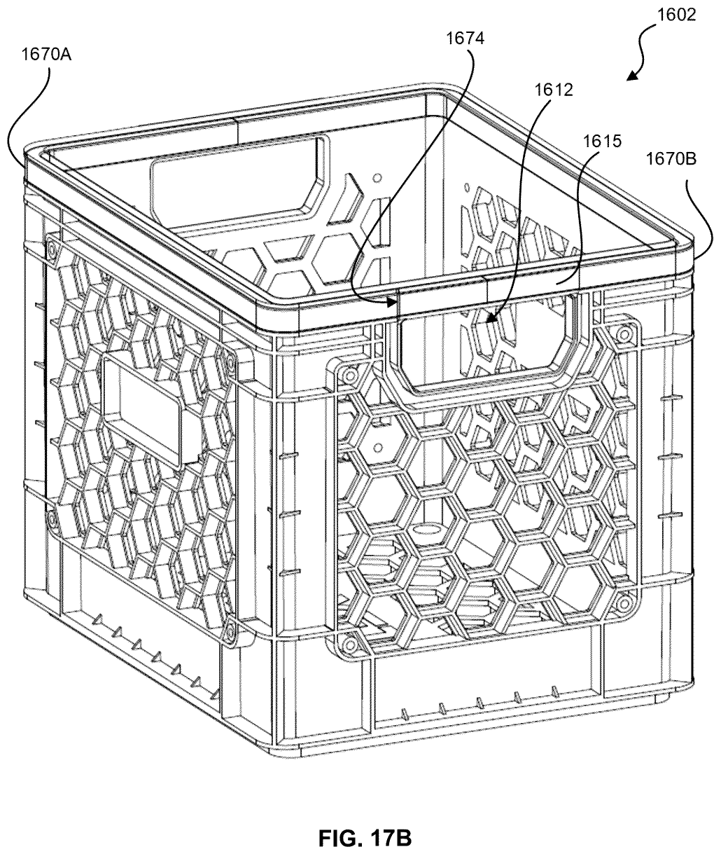

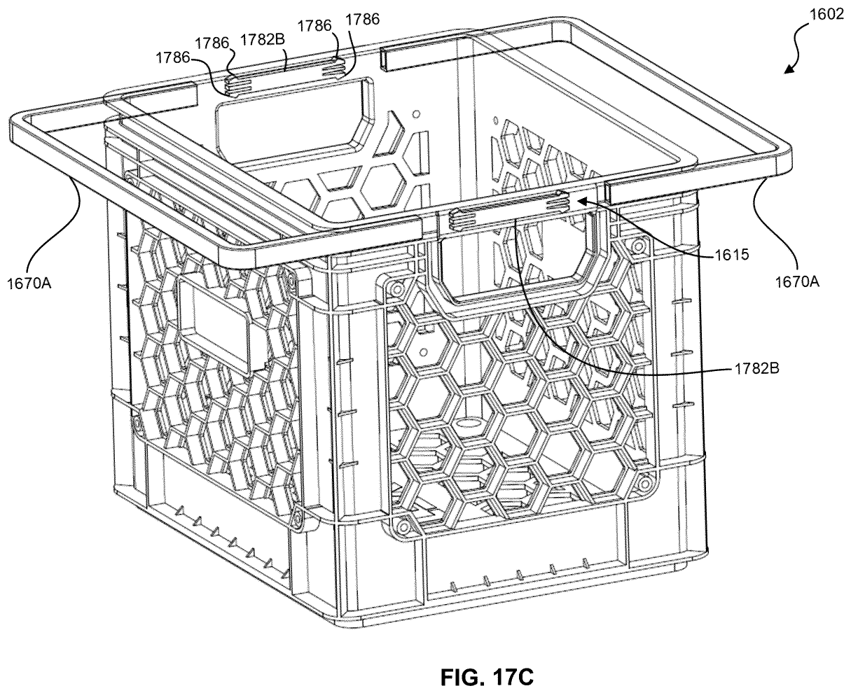

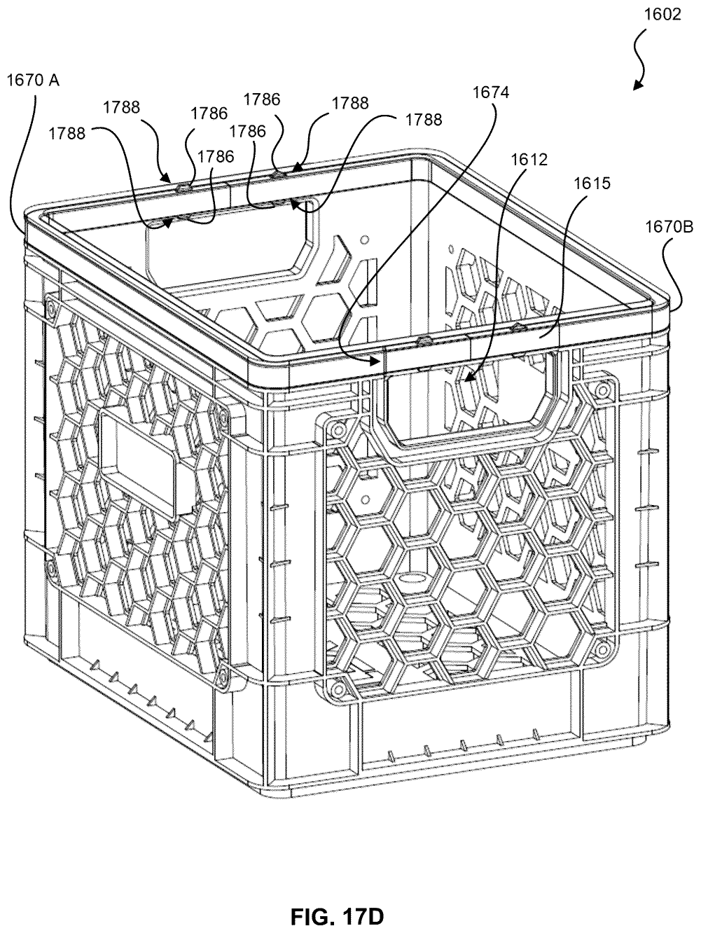

FIG. 17A shows the crate 1602 with an exploded view of the two band halves 1670A and 1670B and a band connector 1782A. For clarity of description, the top portion of the crate 1602 (including the grasping portion 1615) is depicted as transparent in FIG. 17A. As described with reference to FIGS. 16A-16C, the two band halves 1670 may be joined. Referring to FIG. 17A, the two band halves 1670 may be joined via the band connector 1782A. The band connector 1782A may comprise a splice insert connector. The band connector 1782A may be configured to fit into a hollow portion of each of the two band halves 1670, for example, extending in from the band half ends 1676. Additionally or alternatively, the band connector 1782A may be configured as an interference fit connector, for example, configured to interfere with internal surfaces of the band halves 1670. The band connector 1782A may comprise one or more (e.g., four) interference ribs 1784. The interference ribs 1784 may comprise resilient, deformable ribs. The interference ribs 1784 may be formed of a resilient material (e.g., metal, metal sheet, etc.). Additionally or alternatively, the interference ribs 1784 may be spring-loaded. The interference ribs 1784 may project out of a top and/or bottom surface of the band connector 1782A.

The interference ribs 1784 may be configured to deform, for example, from a rest or equilibrium position. For example, the band connector 1782A and one or more of the interference ribs 1784 may be inserted into a band half 1670 (e.g., second band half 1670B), for example, into a hollow of the band half 1670. The interference ribs 1784 may interfere with the band half 1670 walls, for example, causing the interference ribs to deflect or deform away from the band half 1670 walls and the interference ribs 1784 equilibrium position. Each of the interference ribs 1784 may be sloped such that interference of the band half 1670 walls and the interference ribs 1784, and the continued insertion of the band connector 1782A into the band half 1670 hollow, causes the deflection or deformation of the interference ribs 1784. Following insertion of the band connector 1782 into the band halves 1670, the resilience of the interference ribs 1784, producing a return force to return the interference ribs 1784 to their equilibrium state, may cause an interference of the interference ribs 1784 with the interior of the walls of the band halves 1670. Upon installation and joining of the band connector 1782A to both the first band half 1670A and the second band half 1670B, the interference of the interference ribs 1784 with the internal walls of the band halves 1670 may operate to join and hold the band halves 1670 together. In one or more example configurations, the surfaces of the interference ribs 1784, for example, that interface with the internal walls of the band halves 1670 may be textured (e.g., knurled, ribbed, rubberized, etc.) to increase the force operable to separate the two band halves 1670. For example, the interference ribs 1784 may be textured to increase the coefficient of friction between the interference ribs 1784 and the internal walls of the band halves 1670. In some cases, the interference fit between the band connector 1782 and the band halves 1670 may permanently join the band halves 1670 (e.g., non-destructively). Alternatively, in some other embodiments the band connecter 1782B may removably join the band halves 1670, such that a force greater than a non-zero threshold force may be applied to the band halves 1670 to separate the band halves 1670.

FIG. 17B shows the crate 1602 of FIG. 17A with the two band halves joined via the band connector (e.g., band connector 1782A shown in FIG. 17A). For clarity of description and depiction, the top portion of the crate 1602 (including the grasping portion 1615) is depicted as transparent in FIG. 17B. As can be seen in FIG. 17B, when the two band halves 1670 are joined, the band connector 1782 may be resident within the two band halves 1670. Additionally, the two band halves may be maintained in connection and installation to the crate 1602 via the band connector 1782. Additionally, in the example configuration of FIG. 17B, the band connector 1782A is resident in the area of the handle 1612 and grasping portion 1615. Accordingly, when installed, the band connector 1782A may provide additional strength to the handles 1612 and grasping portion 1615 of the crate. Additionally, as the band halves may be joined in the conduit section 1674 (depicted as transparent in FIG. 17B), the seam between the band halves 1670 may be hidden.

FIG. 17C shows the crate 1602 with an exploded view of the two band halves 1670A and 1670B, and an alternative example band connector 1782B. For clarity of description and depiction, the top portion of the crate 1602 (including the grasping portion 1615) is depicted as transparent in FIG. 17C. The band connector 1782B of FIG. 17C may be substantially similar to the band connector 1782A of FIGS. 17A and 17B, unless as explicitly described herein. The band connector 1782B may comprise a snap-fit connector. The connector 1782 may be shaped and configured to be inserted into each of the band halves 1670, for example, into hollow portions extending from the band half ends 1676.

The band connector 1782B may comprise one or more (e.g., four) snap-fit tabs 1786. The snap-fit tabs 1786 may be elastically deformable tabs extending from the band connector 1782B. Like the band connector 1782A of FIG. 17A, upon installation or joining of the two band halves 1670, a first side of the band connector 1782B may be inserted into the hollow of the first band half 1670A. The walls of the first band half 1670A may interfere with the snap-fit tabs 1786. Interference of the snap-fit tabs 1786 may cause the snap-fit tabs 1786 to deform (e.g., elastically) away from an equilibrium state. The snap-fit tabs 1786 may comprise sloped surfaces configured to interfere with the walls of the first band half 1670A to deflect the snap-fit tabs 1786 as the band connector 1782B is inserted into the first band half 1670A. The first band half 1670A may comprise a snap-fit cutout (e.g., as depicted in FIG. 17D) corresponding to each of the snap-fit tabs 1786. With continued insertion of the band connector 1782B into the hollow of the first band half 1670A, the snap-fit tabs 1786 may reach a corresponding snap-fit cutout (in the first band half 1670A). Upon reaching the snap-fit cutout, the corresponding snap-fit tab 1786 may return toward its equilibrium state into and engaging the snap-fit cutout. Engagement of the snap-fit tab 1786 with the snap-fit cutout may operate to connect the band connector 1782B to the first band half 1670A. A substantially similar process may be repeated for installing the snap-fit connector 1782B to the second band half 1670B, thereby joining the first band half 1670A and the second band half 1670B via the snap-fit band connector 1782B. A second band connector 1782B may be installed for a second band half end 1676 of the first band half 1670A and the second band half 1670B.

FIG. 17D shows the crate 1602 of FIG. 17C with the two band halves 1670 joined via the band connector (e.g., band connector 1782B shown in FIG. 17C). For clarity of description and depiction, the top portion of the crate 1602 (including the grasping portion 1615) is depicted as transparent in FIG. 17D. As described with reference to FIG. 17C and as depicted in FIG. 17D, each of the band halves 1670 may include one or more snap-fit cutouts 1788. Further, as described, upon installation of the snap-fit band connector (e.g., of FIG. 17C) to each of the band halves 1670, the snap-fit tabs 1786 may reform (e.g., toward equilibrium) into the snap-fit cutouts 1788, thereby holding the band connector 1782B to each band half 1670 and joining the two band halves 1670 via the band connector 1782A. In some cases, when the snap-fit tabs 1786 reform into the snap-fit cutouts 1788, the band halves 1670 may be permanently joined (e.g., non-destructively). Alternatively, in some other embodiments the band connecter 1782B may removably join the band halves 1670, such that a force greater than a non-zero threshold force may be applied to the band halves 1670 to separate the band halves 1670.

Although the band 1668 has been described and depicted as being installed to the crate 1602 via the band connectors 1782, the band 1668 may additionally or alternatively be fixed to the crate 1602. For example, in addition or alternatively to the band connector 1782, the band may be riveted and/or screwed to the crate. For example, rivets and/or screws may be placed through the crate (e.g., from the inside of the sides 1604, for example, at the back side of the track (e.g., track 1680 of FIG. 17A) into the band 1668. Additionally or alternatively, rivets and/or screws may be passed through the grasping portion 1615 into the band 1668. The rivets and/or screws may operate to maintain the band 1668 engaged with the crate and/or to add stability, strength, and/or load distribution to the crate via the connection points of the crate and the band 1668.

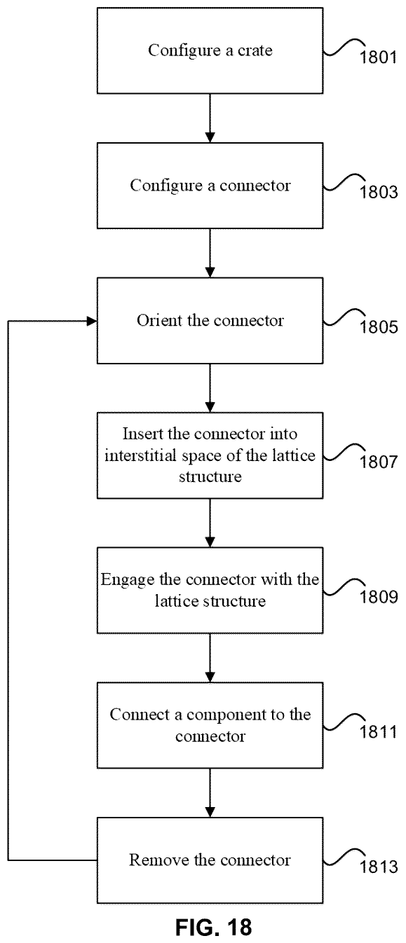

FIG. 18 depicts an example method associated with crates and connectors (e.g., crates 102, crates 1602, and connectors 442). At step 1801, a crate may be configured. Configuring the crate of step 1801 may comprise configuring a crate to include one or more features of crate 102 and/or crate 1602 (e.g., crate 102 as described with reference to FIGS. 1-15 and crate 1602 described with reference to FIGS. 16A-17D). For example, the crate may be configured to include sides (e.g., four sides) and a bottom. The four sides and the bottom may form a storage area and may define an inside and outside of the crate. One or more of the four sides and the bottom may be configured to include a lattice structure. The lattice structure may comprise a plurality of repeating shapes (e.g., triangles, squares, hexagons, etc.). The lattice structure, and/or the plurality of repeating shapes thereof, may define a plurality of interstitial spaces between the plurality of repeating shapes. Each of the plurality of interstitial spaces may define a shape substantially similar to the repeating shapes of the lattice structure. Each of the plurality of repeating shapes may be substantially hexagonal. Additionally, a portion of each of the plurality of interstitial spaces may be hexagonally defined.

At step 1803, a connector may be configured. Configuring the connector of step 1803 may comprise configuring a connector to include one or more features of connector 442 as described herein (e.g., connector 442 as described with reference to FIGS. 11A-15). For example, the connector, or a portion thereof, may be configured to be substantially complimentarily shaped to the plurality of repeating shapes of the lattice structure. Additionally or alternatively, the connector, or a portion thereof, may be configured to be complimentarily shaped to the interstitial space of the lattice structure. The complimentary shape of the connector may comprise a hexagonal shape. The portion of the connector configured to be hexagonally shaped may comprise six sides and six vertices. The connector may be engaged with the lattice structure. For example, as described herein, the connector may comprise a connector flange. The connector flange may be configured to engage the lattice structure. Additionally or alternatively, the connector may comprise one or more retainers. The retainers may be configured to engage the lattice structure. For example, the retainers and connector flange may be configured to, upon installation of the connector to the crate, engage the lattice structure.

The configuring the connector of step 1803 may further comprise configuring the connector to include a plurality of mounting points. One or more of the mounting points may comprise an aperture, for example, through the connector. Each of the apertures may be configured to receive one or more fasteners. Additionally or alternatively, the apertures may be configured to mount a component (e.g., a second crate, a second connector, an accessory, a surface etc.) to the connector. Additionally or alternatively, the plurality of mounting points (e.g., apertures) may be configured to provide a plurality of mounting configuration options while maintaining strength and integrity of the connector. For example, the apertures may include a first slotted aperture. The first slotted aperture may extend between two opposing sides (e.g., of the six sides) of the hexagonal shape. The connector may be further configured to include two oblong apertures. Each of the two oblong apertures may be disposed between the slotted aperture and a hexagon vertex (e.g., of the six hexagon vertices).

At step 1805, the connector may be oriented (e.g., by a user). For example, in the example configuration of a hexagonally shaped connector, the connector may be installed to the crate in six orientations. The six orientations may be offset from each other by rotations (e.g., of the connector) in intervals of about 60°. The different orientations (or a portion thereof) may differently orient the mounting points (e.g., as described with reference to FIG. 12). The differently configured components may be mounted to the differently oriented mounting points.

At step 1807, the connector may be inserted (e.g., by a user) into an interstitial space of the plurality of interstitial spaces. For example, the connector may be inserted from the outside of the carton into the interstitial space. Alternatively, the connector may be inserted from the inside of the carton into the interstitial space.

At step 1809, the connector may be engaged with the lattice structure, for example, to retain (e.g., hold) the connector in the interstitial space. For example, a user may cause engagement of the connector with the lattice structure. For example, upon the insertion of the connector into the interstitial space (e.g., of step 1807), the retainers may engage the lattice structure. With continued insertion, the retainers may be deflected from a resting position. With continued insertion, the retainers may clear the lattice structure and snap back to their resting position. In this position, the retainers and connector flange may engage the lattice structure retaining the connector in the interstitial space of the lattice structure. Additionally, the engagement of the connector with the lattice structure may allow the mounting and/or connection of one or more components to the crate. Steps 1805 through 1809 may be understood as installing the connector to the crate.

At step 1811, one or more components may be connected to the connector, for example, via one or more of the mounting points. In turn, the one or more components may be connected to the crate. The one or more components may comprise, for example, a surface (e.g., a wall), a second crate, a second connector (e.g., engaged with a second crate), one or more accessories (e.g., holders, dividers, etc.).

At step 1813, the connector may be removed from the crate. For example, a user may grip and pull or push the connector out of the interstitial space of the lattice structure. For example, a user may push the connector with enough force to cause the lattice structure to engage the retainer and deflect the retainer from its resting position. With continued movement of the connector, the retainer may clear the lattice structure. Once cleared, the connector may be removed from the lattice structure. Additionally, once cleared, the retainers may snap back to their resting/natural position. In some examples, any components connected to the connector may be removed prior to removal of the connector from the crate. Following step 1813, the example method of FIG. 18 may return to step 1805.

The present disclosure is disclosed above and in the accompanying drawings with reference to a variety of examples. The purpose served by the disclosure, however, is to provide examples of the various features and concepts related to the disclosure, not to limit the scope of the disclosure. One skilled in the relevant art will recognize that numerous variations and modifications may be made to the examples described above without departing from the scope of the present disclosure.

The following paragraphs (A1) through (A11) describe examples of apparatuses that may be implemented in accordance with the present disclosure.

(A1) An apparatus comprising: a first side; a second side; a third side; a fourth side; and a bottom, wherein the first side, the second side, the third side, the fourth side, and the bottom together form a storage area and an opening to access the storage area, wherein the first side, the second side, the third side, the fourth side and the bottom each comprise a series of ports, wherein a side pattern of the series of ports for the first side, the second side, the third side, the fourth side is different than a bottom pattern of the series of ports for the bottom, wherein the series of ports is configured to receive a fastener, and wherein the first side, the second side, the third side, the fourth side, and the bottom each comprise a repeating ventilated lattice structure.

(A2) The apparatus as described in paragraph (A1), further comprising a lid configured to cover the opening.

(A3) The apparatus as described in paragraph (A2), wherein the lid further comprises a latch configured to releasably engage a top portion of the first side, the second side, the third side, or the fourth side.

(A4) The apparatus as described in any of paragraphs (A1)-(A3), wherein the lid is configured to form a friction fit with the first side, the second side, the third side, and the fourth side in a covered position.

(A5) The apparatus as described in any of paragraphs (A1)-(A4), wherein the first side, the second side, the third side, and the fourth side each comprise a handle.

(A6) The apparatus as described in paragraph (A5), wherein the handles further comprise a grip assembly comprising crown extensions extending into the storage area.

(A7) The apparatus as described in any of paragraphs (A1)-(A6), wherein: the apparatus is cuboid.

(A8) The apparatus as described in any of paragraphs (A1)-(A7), wherein the repeating ventilated lattice structure comprises a plurality of hexagon-shaped structures.

(A9) The apparatus as described in any of paragraphs (A1)-(A8), further comprising a connector removably disposed in an interstitial space of the repeating ventilated lattice, wherein the connector includes at least one opening configured to receive a fastener.

(A10) The apparatus as described in any of paragraphs (A1)-(A9), further comprising a plurality of feet removably attached to the series of ports for the bottom.

(A11) The apparatus as described in paragraph (A10), wherein the plurality of feet are reversible, and wherein each of the plurality of feet comprises a gripping side and a slidable side opposite the gripping side.

The following paragraphs (S1) through (S5) describe examples of systems that may be implemented in accordance with the present disclosure.

(S1) A modular storage system comprising: a plurality of crates, each comprising: a first side, a second side, a third side, and a fourth side, wherein the first side, the second side, the third side, and the fourth side each comprises a handle. Each of the plurality of crates further comprising a bottom; a storage area, wherein the first side, the second side, the third side, the fourth side, and the bottom together form the storage area; an opening, wherein the first side, the second side, the third side, and the fourth side together form the opening; and at least one lid configured to cover the opening of at least one of the plurality of crates, wherein the at least one lid comprises a series of retention areas configured to engage the bottom of a second crate, of the plurality of crates, stacked on top of the at least one lid.

(S2) The modular storage system as described in paragraph (S1), wherein each of the plurality of crates further comprises feet, wherein the feet are spaced apart such that the feet of the second crate engage the series of retention areas.

(S3) The modular storage system as described in any of paragraphs (S1)-(S2), wherein each of the plurality of crates further comprises feet, wherein each of the feet comprises a first side having a first coefficient of friction, and a second side having a second different coefficient of friction.

(S4) The modular storage system as described in paragraph (S3), wherein each retention area of the series of retention areas comprise a surface positioned lower vertically than a top surface of the lid.

(S5) The modular storage system as described in any of paragraphs (S1)-(S4), wherein each of the first side, the second side, the third side, and the fourth side comprises a repeating lattice structure. The modular storage system further comprising: one or more connectors, each connector being shaped to fit into interstitial space in the repeating lattice structure and configured to engage the repeating lattice structure, wherein each connector includes at least one opening configured to receive a fastener.

What is claimed is:

1. A storage system comprising:
a crate comprising:
a first side;
a second side;
a third side;
a fourth side;
a bottom;
a channel formed in and extending around the first side, the second side, the third side, and the fourth side; and
a first handle formed in the first side and a second handle formed in the third side, wherein the channel comprises a first enclosed channel portion in an area of the first handle and a second enclosed channel portion in an area of the second handle; and
a band comprising two band portions disposed in the channel, the band configured to circumscribe the crate in the channel,
wherein the two band portions are joined in the first enclosed channel portion and the second enclosed channel portion.

2. The storage system of claim 1, wherein the channel is formed proximate a top of the first side, the second side, the third side, and the fourth side.

3. The storage system of claim 1, wherein each of the band portions comprises hollow portions and wherein the two band portions are joined via one or more band connectors disposed in the hollow portions.

4. The storage system of claim 3, wherein the one or more band connectors comprise one of more of:
interference band connectors configured to interfere with inner walls of the hollow portions; or
snap-fit connectors configured to snap-fit to each of the band portions.

5. The storage system of claim 1, wherein each of the first side, the second side, the third side, and the fourth side comprises a repeating lattice structure.

6. The storage system of claim 5, further comprising one or more connectors, each connector being shaped to fit into interstitial space in the repeating lattice structure and configured to engage the repeating lattice structure, wherein each connector includes at least one opening configured to receive a fastener.

7. The storage system of claim 6, wherein the connector further comprises:
a base;
walls extending from a portion of the base;
one or more flanges extending from a portion of the walls;
one or more fastener points each comprising an aperture in the base of the connector; and
one or more retainers configured to engage a lattice structure of a crate,
wherein the connector further comprises at least three flat sides.

8. The storage system of claim 1, wherein the channel comprises at least three sides and wherein each of the first enclosed channel portion and the second enclosed channel portion comprises four sides.

9. A connector comprising:
a base;
walls extending from a portion of the base;
one or more flanges extending from a portion of the walls;
one or more fastener points each comprising an aperture in the base of the connector; and
one or more retainers configured to engage a lattice structure of a crate,
wherein the connector further comprises at least three flat sides.

10. The connector of claim 9, wherein the connector is further configured to engage the lattice structure of the crate and secure the connector to the lattice structure of the crate.

11. The connector of claim 9, wherein the one or more retainers are further configured to snap-fit engage the lattice structure of the crate.

12. The connector of claim 9, wherein the connector is further configured to:
engage the lattice structure, on a first side of the lattice structure, via the one or more flanges; and
engage the lattice structure, on a second side of the lattice structure, via the one or more retainers,
wherein the engagement of the one or more flanges with the first side of the lattice structure, and the engagement of the one or more retainers with the second side of the lattice structure secures the connector to the crate.

13. The connector of claim 9, wherein the connector comprises a hexagon shape comprising six sides and six vertices, and wherein the one or more fastener points comprise a first slotted aperture extending between two opposing hexagon sides, and two oblong apertures each of the two oblong apertures being disposed between the first slotted aperture and one of the six vertices.

14. A method comprising:
configuring a crate, comprising an inside and an outside, to include a lattice structure comprising a plurality of repeating shapes and a plurality of interstitial spaces between the plurality of repeating shapes;
configuring a connector to:
be complimentarily shaped to the plurality of repeating shapes of the lattice structure;
engage the lattice structure; and
include a plurality of mounting points;
inserting the connector into an interstitial space of the plurality of interstitial spaces;
causing engagement of the connector with the lattice structure such that the connector is retained in the interstitial space; and
connecting, via one or more of the plurality of mounting points, a component to the connector.

15. The method of claim 14, wherein the plurality of repeating shapes are substantially hexagonal, and wherein the complimentarily shaped connector comprises a hexagonally shaped connector.

16. The method of claim 14, wherein the inserting further comprises one or more of:
inserting, from the inside of the crate, the connector into the interstitial space of the plurality of interstitial spaces; or
inserting, from the outside of the crate, the connector into the interstitial space of the plurality of interstitial spaces.

17. The method of claim 14, wherein the plurality of mounting points comprise a plurality of apertures in the connector, each configured to receive a fastener.

18. The method of claim 17, wherein the complimentary shape of the connector comprises a hexagonal shape comprising six sides and six vertices, and wherein the plurality of apertures comprise a first slotted aperture extending between two opposing of the six sides, and two oblong apertures, wherein each of the two oblong apertures are disposed between the first slotted aperture and one of the six vertices.

19. The method of claim 14, wherein the causing the engagement further comprises, causing the connector to snap-fit engage the lattice structure such that the connector is retained in the interstitial space.

20. The method of claim 14, further comprising:
forming a channel around the outside of the crate, the channel being configured to receive a reinforcement band.
